(19) United States
(12) Patent Application Publication
(10) Pub. No.: US 2009/0265229 A1
(43) Pub. Date: Oct. 22, 2009

(54) SYSTEM, METHOD, AND PROGRAM PRODUCT FOR BUYER DRIVEN SERVICES E-COMMERCE

(76) Inventor: Ranbir S Sidhu, Santa Rosa, CA (US)

Correspondence Address: RANBIR S SIDHU, 2027 Bedford St, Santa Rosa, CA, 95404, US

(21) Appl. No.: 12/106,067

(22) Filed: Apr. 18, 2008

(51) Int. Cl. G06Q 30/00

(52) U.S. Cl. 705/14; 705/26; 705/27

(57) ABSTRACT

A buyer driven e-commerce for services is presented. The buyer connects to a web site for the purpose of locating a provider of a service. The buyer, choosing to place an ad on the web site, chooses a category of services that corresponds to a required service. The buyer then chooses a service option related to the category selected. The buyer then provides information to questions regarding the service option. The buyer also provides a video file to further describe and clarify the required service. The information and the video file are posted to the web site as the ad. The provider connecting to the web site accesses the ad under the service option under the category. The provider then chooses to bid on the required service. The buyer reviews bids for the ad. After reviewing the bids, the buyer chooses an acceptable provider for the required service.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention generally relates to online buyer driven commerce. More particularly, the invention relates to methods and systems of locating and determining the lowest price for the most optimum service provider to fulfill service needs, using a competitive bidding process.

### BACKGROUND OF THE INVENTION

Historically, service requests have consisted of requests for proposals or quotations (RFP/RFQ), bidding or tenders based on details provided by the consumer, or a service provider physically visiting the consumer's location, to gather details and determine a price quote for service required. Traditional systems used in locating service providers include, without limitation, searching directories, newspapers, yellow pages, local stores, word of mouth, online listings, etc. Due to inaccuracies in information, limitations in service coverage and options, or outdated information, prior methods are restricted in acquiring the lowest possible price from the most appropriate or competent service provider, for the level of service desired. This result's in increased risk of contracting incorrect service providers for the service needs at hand and ultimately dissatisfied consumers. Further drawbacks result from confusion in consumers having to choose from large listings of unfamiliar service providers, without knowledge of factors such as, but not limited to, quality, skill, market rates, materials and real time evidence of past experience. The lack of transparency and precision of information to make a confident decision when choosing a service provider has resulted in inefficiencies, increased expense for the consumer and a need to compromise integrity when choosing service providers. Locating the right service provider to fit a consumer's needs leaves one to gamble on service options advertised in the open market in the hope of making the right decision. Communicating desires effectively and making the correct decision based on price, skill and reputation can be a time consuming and error prone task.

Since the advent of the Internet a number of online services have emerged catering to consumer demand, these are comprised of classified advertising and variations of auction methods and service matching techniques. Some of these systems enable consumers to advertise product or service requirements and receive responses in accordance to demand advertised using a reverse auction system, or in another version consisting of a forward auction process whereby the consumer browses listings of ads and places bids on items of interest. The general sequence and flow of online bidding is well known in prior art, as it has predominantly been similar in most prior applications, ever since these services first came online.

A majority of online services cater primarily to a product-oriented market, focusing on attributes of the product for sale or in demand. Online services that do cater to service demands are limited in services covered and or cater to intangible service requests, whereby a computer or other device connected to the internet suffices in the transaction from, but not limited to requests, agreements, production, communication and review of work, for example, without limitation, programming, writing, website, design, etc., through an online shared workspace. Such systems have not been seen to adequately address or cater to everyday or niche services, in many cases the architecture poses limitations in practically serving the market intended.

Another variation of systems in prior art allows users to advertise service needs online and for pre-registered businesses to respond and be matched to those needs. Or in another variation the charging of fees when service providers are matched with consumer demands, whereby the system acknowledges response of an offer from a service provider to an ad, and the retrieval of that response by the consumer placing the ad, similar to an automated directory. This method does not guarantee a service provider paying a fee for the retrieved offer will receive the service contract and thus poses a restriction on all bidders. Moreover fee-based systems prior to service fulfillment can be considered a deterrent to any service provider. Further there is no competition or price transparency in these solutions, leading to increased expense incurred by the consumer. In another variation some systems maintain a database of service providers that allow for searches to be made for stores and services using keywords, as do search engines. The drawback in these methods stem from inaccuracies in producing the most optimum listed results for the consumer, based on the service need. This can lead to misguidance for a consumer in determining which service provider is the best possible fit. Search engines constantly change algorithms in relation to web crawlers and data mining in order to provide fair, optimum results to the consumer and limit manipulation in ranking by websites. This still does not provide any indication of which service provider might be the most optimum, geographical fit for the request at hand. Results displayed at the top of a listing are not always the most optimum choices due to methods used in calculating display of results.

Furthermore, results produced by prior art in searching services relevant to locality, generally have the disadvantage of being limited to primarily conventional bricks and mortar businesses, without recognition or accommodation of other service providers in existence. Further limitations in search for products and services in other systems, provide no real indication of how specialized or concentrated services or products are to each store or service provider, regardless of being listed as an online or conventional business. This results in a display similar to that of a local directory, with rank dependant on, but not limited to, alphabetic order, locality and or key words, which leaves the consumer open to greater risk, due to lack of analysis in optimizing and prioritizing results correctly, based on actual needs. Further limitations in prior art stem from methods and calculations including, but not limited to, algorithms adopted in performing search. Even though these are constantly changed to ensure fairness and refine results, manipulation in ranking by store operators persists. Changes made by store operators within, but not limited to, web sites, to accommodate, exploit and scrutinize search methods adopted by search systems/engines to gain higher ranking, is of constant threat, resulting in distorted results. Other methods include, link popularity and keyword/phrase occurrence, such methods are again open to manipulation and lack in analyzing the true degree of emphasis and concentration in services offered.

In view of the foregoing, there is a need for a method and system for consumers and service providers to locate each other online, to ensure the most optimum fit for supply and demand of services, promote competitive prices and provide the consumer with a wider range of services and providers from which to choose.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow chart illustrating an exemplary process for entry and direction of a visitor in a buyer driven bidding system based on choices made by the visitor, in accordance with an embodiment of the present invention;

FIG. 2 is a flow chart illustrating an exemplary process for a consumer to create an ad for a desired service in a buyer driven bidding system, in accordance with an embodiment of the present invention;

FIG. 3 is a flow chart illustrating an exemplary process for a service provider to respond to an ad for a service request in a buyer driven bidding system, in accordance with an embodiment of the present invention;

FIG. 4 is a flow chart illustrating an exemplary appointment system of a buyer driven bidding system, in accordance with an embodiment of the present invention;

FIG. 5 is a flow chart illustrating an exemplary process for a consumer to choose a service provider in a buyer driven bidding system, in accordance with an embodiment of the present invention;

FIG. 6 is a flow chart illustrating an exemplary feedback system for a buyer driven bidding system, in accordance with an embodiment of the present invention;

FIGS. 7 and 8 are flow charts illustrating an exemplary method for setting up an online store in a buyer driven bidding system, according to an embodiment of the present invention. FIG. 7 illustrates the method from entry point S to a point K, and FIG. 8 illustrates the method from point K to the end of the process;

FIG. 9 is a flow chart illustrating an exemplary process for a consumer to search for an online store on a buyer driven commerce site, in accordance with an embodiment of the present invention;

FIG. 10 is a flow chart illustrating an exemplary process for redeeming a coupon and submitting feedback for an online store on a buyer driven commerce site, in accordance with an embodiment of the present invention;

FIG. 11 illustrates a client-server network architecture 1100 that, when appropriately configured or designed, can serve as a computer network in which the invention may be embodied; and

FIG. 12 shows a representative hardware environment that may be associated with the server computers and/or client computers of the previous Figure, in accordance with one embodiment.

Unless otherwise indicated illustrations in the figures are not necessarily drawn to scale.

### SUMMARY OF THE INVENTION

To achieve the forgoing and other objects and in accordance with the purpose of the invention, a system, method and product for buyer driven e-commerce for services is presented.

In one embodiment, a method for a buyer driven e-commerce for services is presented. The method includes steps of the buyer connecting to a web site for the purpose of locating a provider of a service. The buyer, choosing to place an ad on the web site, chooses a category of services that corresponds to a required service. The buyer then chooses a service option related to the category selected. The buyer then provides information to questions regarding the service option. The buyer also provides a video/image file to further describe and clarify the required service. The buyer then requests the information and the video/image file to be posted to the web site as the ad under the service option under the category. The provider connecting to the web site for the purpose of locating buyers of the provider's services accesses the ad under the service option under the category. The provider then chooses to bid on the required service. The buyer reviews bids for the ad. After reviewing the bids, the buyer chooses an acceptable provider for the required service. Other embodiments provide for the steps of the buyer providing feedback regarding the acceptable provider to be posted on the web site and used in rating the provider and the feedback includes a video/image file illustrating service provided by the provider. Another embodiment the step of the provider providing feedback regarding the buyer to be posted on the web site and used in rating the buyer. In a further embodiment the step of choosing an acceptable provider further includes the buyer reviewing posted feedback, rating of the provider and discussing performance with past buyers via VoIP. In another embodiment the step of choosing to bid on the required service further includes the provider reviewing posted feedback and rating of the buyer. Other embodiments include the steps of the buyer and the provider communicating via VoIP (Voice over Internet Protocol) to facilitate the bidding process, the provider requesting an appointment with the buyer and the buyer responding via an automated appointment system on the web site, the bid being posted on the web site by the provider and the provider setting up a store on the web site. In still another embodiment the step of setting up a store further includes providing a video/image file as a means for introducing the provider and services provided by the provider. In yet other embodiments include the step of the buyer searching stores on the web site using categories and service options and the step of the buyer receiving a map indicating locations of providers resulting from buyer's search.

In another embodiment, a system for buyer driven e-commerce for services is presented. The system includes a web site accessible to buyers of services and providers of services, a plurality of categories and related service options on the web site from which the buyer may choose to place an ad for required service, informational questions, presented to the buyer, regarding the service option where the buyer chooses to place the ad, means for the buyer choosing to place the ad to include, in the ad, a video/image file to further describe and clarify the required service, means for posting the buyer's ad under the service option under the category, browsing means for providing the provider access to the buyer's ad, means for allowing the provider to bid on the buyer's ad, means for the buyer to review bids on the ad and after reviewing the bids, means for the buyer to choose an acceptable provider for the required service. Other embodiments include means for the buyer to provide feedback regarding the acceptable provider to be posted on the web site and used in rating the provider and means for the provider to provide feedback regarding the buyer to be posted on the web site and used in rating the buyer. Further embodiments include means for the buyer to review posted feedback, rating of the provider, discussing performance with past buyers via VoIP and means for the provider to review posted feedback and rating of the user. Other embodiments include means for the buyer and the provider to communicate via VoIP to facilitate the bidding process means for the provider to request an appointment with the buyer and the buyer to respond via an automated appointment system on the web site and means for the provider to post the bid on the web site. Still other embodiments include means for the provider to set up a store on the web site and means for the provider to provide a video/image file as means for introducing the provider and services provided by the provider. Yet another embodiment includes means for the buyer to search stores on the web site using categories and service options.

In yet another embodiment a method for buyer driven e-commerce for services is presented. The method includes steps for the buyer to connect to a web site for the purpose of locating a provider of a service, steps for the buyer to choose a category of services that corresponds to a required service, steps for the buyer to choose a service option related to the category selected, steps for the buyer to provide information to questions regarding the service option and a video/image file to further describe and clarify the required service, steps for the buyer to request the information and the video/image file to be posted to the web site as an ad under the service option under the category, steps for the provider to connect to the web site for the purpose of locating buyers of the provider's services, steps for the provider to set up a store on the web site, steps for the provider to access the ad under the service option under the category, steps for the provider to choose to bid on the required service, steps for the buyer and the provider to communicate via VoIP to facilitate the bidding process, steps for the buyer to review bids for the ad, steps for the buyer to choose an acceptable provider for the required service, steps for allowing the buyer to provide feedback regarding the acceptable provider, and steps for allowing the provider to provide feedback regarding the buyer. Another embodiment includes steps for the provider to request an appointment with the buyer and the buyer to respond via an automated appointment system on the web site. Yet another embodiment includes steps for the buyer to search stores on the web site using categories and service options.

In another embodiment a computer program product for buyer driven e-commerce for services is presented. The computer program product includes computer code for a web site accessible to buyers of services and providers of services, computer code that provides a plurality of categories and related service options on the web site from which the buyer may choose to place an ad for required service, computer code that provides informational questions, presented to the buyer, regarding the service option where the buyer chooses to place the ad, computer code that provides means for the buyer choosing to place the ad to include, in the ad, a video/image file to further describe and clarify the required service, computer code that provides means for posting the buyer's ad under the service option under the category, computer code that provides browsing means for providing the provider access to the buyer's ad, computer code that provides means for the provider to set up a store on the web site, computer code that provides means for allowing the provider to bid on the buyer's ad, computer code that provides means for the buyer to review bids on the ad, computer code that provides means for the buyer to review posted feedback, rating of providers and discussing performance with past buyers via VoIP, computer code that provides means for the buyer and the provider to communicate via VoIP to facilitate the bidding process, computer code that provides means for the buyer to choose an acceptable provider for the required service, computer code that provides means for the buyer to provide feedback regarding the acceptable provider, computer code that provides means for the provider to provide feedback regarding the buyer and a computer-readable medium that stores the computer code. A further embodiment includes computer code that provides means for the provider to request an appointment with the buyer and the buyer to respond via an automated appointment system on the web site. Yet another embodiment includes computer code that provides means for the buyer to search stores on the web site using categories and service options.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings. The preferred embodiment of the present invention serves to conveniently identify and locate quality service providers at competitive prices for a consumer, or as alternately referred to as a buyer, to confidently make an informed decision and ensure the consumer has the option to choose from the most optimum choice of service providers relevant to their service need. Markets served by the preferred embodiment include, without limitation, consumer-to-consumer, business-to-business and business-to-consumer. In the preferred embodiment, the system incorporates technology in communication and video presentation of consumer service requests (ads) in an online competitive bidding environment through a website, to enable consumers to describe service needs clearly. This assists service providers and consumers to locate and fulfill requests with mutual convenience, speed and accuracy, enabling users to locate the right service provider to fit a particular budget in a particular locality for a desired quality or level of service. The system according to the preferred embodiment also promotes new opportunities for service providers in existing markets and assists in the development of new service markets.

Problems resolved by embodiments of the present invention include without limitation, means of and convenience in, location of reputable existing or new service providers in one place quickly and easily, with options to select service at a suitable price using a reliable system. Saving time by reducing the need to search through directories such as, but not limited to, the “Yellow Pages”, newspaper ads, conventional methods in finding service providers, comparison-shopping and making inquires. Embodiments of the present invention also reduce miscommunication issues and time spent making contact with relevant parties. Further, currently known online systems primarily cater to conventional service categories, through conventional service providers, for example, without limitation, licensed professionals or businesses that are limited to servicing conventional needs, only. This restricts development and discovery of new service markets, due to limitations in presentation of conventional service categories only. The lack of depth and coverage of service categories ultimately reduces opportunity for new service providers, for example, without limitation, an ordinary person or group of people, to be discovered and recognized for a skill or talent that may be in demand. This results in missed opportunities to develop new or niche markets and to start new businesses. Further limitations in current systems have lead to, but not limited to reduced competition, increased prices, restricted choices and mismatched relations that have put both consumers and service providers at a disadvantage.

Consumers often require guidance and organization in requesting service to confidently make decisions with convenience and integrity. There is also a need for maintaining a degree of protection or awareness from threat of, without limitation, unethical service providers, inferior workmanship, inflated expenses, etc. Consumers also desire, competitive pricing with options prior to contracting services, enabling them to make preferred choices based on criteria such as, but not limited to, personal circumstances, timing, terms and conditions, warranties, personal assistance/input, materials, balancing quality desired and budget permitted as opposed to considering price only. It is also desirable for all parties to have an option to transact in privacy, without limitation, in exposure of identity in service needs and service bids.

Using a system according to an embodiment of the present invention, one can leave an honest opinion of service performed comfortably, without threat of direct retaliatory feedback or backlash from the other party, resulting in reliable references. Consumers also need a means to accurately locate service stores most relevant to needs as opposed to trial, error and elimination, which can be costly. Furthermore, protection and warning for service providers from problematic consumers or those consumers to be cautious of in terms of payment or other reason, is desirable to service providers. The preferred embodiment enables consumers and service providers to conduct business in a pressure free, unrestricted and trusting environment. Overall, prior art has not been seen to adequately satisfy consumer confidence and fulfill voids in service demands, integrity and prices, through the available pool of services and skills in the market place.

The preferred embodiment enables consumers to avoid cold calling for quotes or receiving irritating service calls due to initiating enquiries. The preferred embodiment provides a consumer with a sense of direction, confidence, trust and options, through organization, direct communication using Voice over Internet Protocol (VoIP) with relevant parties online and real time video evidence of prior service with previous consumers. Current solutions can leave a consumer in a precarious position, not knowing who to use, trust or ask in obtaining references, with no means of determining the best possible choice. This leaves many consumers having no choice but to gamble in choosing from advertised listings or promotions and hope for the best. Even if a consumer can obtain the information or guidance to service providers, it is possible that this information may be outdated or limited to very few of the actual existing options or potential available in the market, thus restricting comparison in price, quality, etc, and securing the most optimum provider.

The preferred embodiment of the present invention overcomes this by providing broad coverage and comparison of service providers in real time. Current options leave the consumer and service provider at a considerable disadvantage as the two parties are unable to locate each other efficiently or effectively, leading to, but not limited to mismatched relationships, unhappy consumers and service providers, and limited growth for business.

The preferred embodiment provides an adequate means of displaying, communicating and advertising everyday or specialist requests to confidently locate reputable or new service providers without limitation. Clarification in ad service needs using video and or images, as used in the preferred embodiment, promotes accurate quotes and less chance of error in miscommunication of service requirements. In many cases this saves time avoiding the need for viewing appointments. Prior art has primarily used video for the sale of goods in promoting or describing product.

Further benefits of the preferred embodiment include, without limitation, convenience in arranging appointments for viewing and avoiding the need to make special calls to arrange, cancel or change appointment times. This can save time significantly in locating and confirming a change with the relevant party. Due to limitations in services accommodated in current solutions, a need for appointments has not been observed by the prior art.

The solution according to the preferred embodiment provides a means of rating offline stores as well as online stores. Current methods of assessing rating and feedback of offline stores (bricks and mortar) comprise considering criteria such as, but not limited to, community recognition, business awards, chamber of commerce and local media. This works well, however it restricts recognition to a very limited selection of stores, whereas the preferred embodiment of the present invention provides an opportunity for stores, businesses and service providers of all types to be rated and recognized for service attributes.

The preferred embodiment also provides consumers the ability to search for service stores/providers and display listings, based on strength of service relevance to the service required, in order to locate the most appropriate or specialist service provider efficiently, as opposed to trial and error. The preferred embodiment lists service stores in order of hierarchy and concentration to the type of service being searched with options in, but not limited to, proximity and past ratings. Organization and display of service categories/options is important in ensuring ads are placed with relevance categorically by consumers, allowing them to be located quickly and easily by service providers, reducing missed opportunity for all parties and maximizing exposure to the most relative optimum service providers. The preferred embodiment comprises improvements in a feedback system, using technology to promote service providers and enabling service providers to be recognized and appreciated for their true skills. Further enhancements in the preferred embodiment provide, an option to maintain privacy for all parties in advertising and bidding, thus promoting a comfortable and confidential environment for those that prefer it. The preferred embodiment promotes widespread services integrating unconventional services to generally ensure that service needs are catered for without limitation. Integration of various technologies saves time for all parties involved, making it easier to request, clarify and communicate service needs.

The preferred embodiment provides simple questions and options of relevance to be answered by the consumer, with regards to service demands to generally ensure that a service provider has the necessary information prior to evaluating an ad and to, but not limited to, promote clarity in service requests, provide enhanced choices to the consumer, minimize misunderstandings, improve accuracy in bidding, filter and attract the most optimum service providers to bid on the service request. Other solutions provide lengthy, time-consuming questionnaires to fill out, which can be tedious and discouraging when attempting to obtain service.

The preferred embodiment also provides for verification of members and licensed service providers, or accredited professionals through a third party or external source to enhance trust, confidence and comfort for consumers, prior to transacting. Verification systems used by others, consist of methods predominantly limited to verifying identification and age.

Service providers may use the preferred embodiment to expand business geographically, for example, without limiation, to acquire service contracts and advertise service requirements, to locate subcontractors and provide service in localities that they normally would not have means to serve. Similarly, for private individuals, instead of contracting out a particular service need to a service contractor who further employs other subcontractors, one could locate the necessary service subcontractors and save financially by supervising and working with the individuals themselves, for example, without limitation, in building work. The preferred embodiment also promotes opportunities in networking and new partnerships for enterprising service providers in locating other quality service providers with the potential of combining services that offer, but not limited to, new enhanced services, greater value, and expertise to the consumer.

Further drawbacks of current systems matching consumers and service providers through databases include, but not limited to, lack of competition, less control and flexibility for the consumer, outdated information, limitations in serving conventional needs and restricted exposure to those registered in the database only. Choices formulated by an automated system based on price, feedback rating, proximity or other preferences and combinations can be risky and result in a mismatched relationship. Due to, but not limited to, lack of pertinent information or choices being requested or accurately analyzed by the system, prior to making an automated selection or presenting the most optimum service providers from which to choose, thus increasing chances of an inaccurate decision. This results more over in a system driven environment as opposed to a buyer driven environment, as there is less emphasis or opportunity for a consumer to make personal comparisons and control specifics of the ad environment. Choices made in a service-matching environment, can be hasty and prone to error, as the service providers already exist on the system and can be instantly presented in directory format. As opposed to the preferred embodiment that allows for, without limitation, time to evolve, to research service providers, discuss, analyze offers, fulfill viewing appointments and negotiate simultaneously in real time, whilst the ad is active promoting competitiveness by giving other or new service providers an opportunity to enter and bid at any given moment. Some systems allow for a time lapse in allowing service requests to be sent and presented to those affiliated with the system or website, to assess the request and determine a response, again this denies, without limitation, open competition due to the restricted environment and compromises control.

Some current systems require consumer ads to be posted with a price indication, this could be considered a drawback as it limits potential bidders. A consumer may be compromising quality of service and workmanship by stating the maximum price one is willing to pay, possibly encouraging a service provider to use cheaper material or cut other expenses, to win the bid. Naming a maximum price also leaves less room for negotiation, with the possibility of a consumer paying more and, or losing out in a bundled service agreement offer, by deterring a service provider through strict dictation of price, resulting in a restricted environment and missed opportunity. This may work well in a product oriented environment, but is typically impractical in a service oriented market as it is highly unlikely a consumer would know the optimum value of a particular service without knowing information such as, but not limited to, cost of materials, economics of labor, workmanship quality, warranty, discount schemes and other decisions or choices relative, that could define price, at any given time.

Sealed bids are another contemplated variation of obtaining prices for goods and services in privacy. This approach reduces competition, as there is no price transparency between bidders. The preferred embodiment enables privacy for bidders that require it, yet promotes competition in an open environment.

Embodiments of the present invention will be of interest to anyone who requires service and anyone that can provide service, in any geographic region. These embodiments provide means to earn full time or supplementary income for individuals from all walks of life. Interested parties include, but not limited to, professionals, companies, organizations, clubs, government, small businesses and new service providers. The preferred embodiment is a supply and demand system backed up by reference and ratings, incorporating technology for convenience. The preferred embodiment can generally be used by all as it covers the widest array of everyday consumer and business services, to include but not limited to, niche and unconventional service requests. Everyone has a demand for service and providers exist to meet these demands.

One desired characteristic of embodiments of the present invention is to expose unscrupulous service providers and inferior workmanship. Another desired characteristic is to save time through convenience and accuracy for all parties transacting. Another desired characteristic is to identify new markets, increase economic activity and promote opportunity. Further characteristics include, without limitation, improvement in quality of service and reduced expense. Another characteristic is to enhance trust, comfort and protection between consumer and service providers.

The physical structure of the preferred embodiment comprises a series of servers and databases networked to host the application on the Internet. The preferred embodiment operates to serve a network of users/members connected to the Internet via, but not limited to, a computer, mobile or handheld device. The system is programmed using PHP or similar language combining other languages and new technologies to enable enhanced functions. The system operates to assist at an intermediate level and bridge the gap between consumers and service providers. A Peer-to-Peer network, Content Delivery Network and other third party technologies, or means are incorporated without limitation, for communication and streaming content such as, but not limited to, audio, video or images between members in some embodiments. File sharing may be used by consumers in describing ads and, or service providers in promoting business ads or online stores in a Peer-to-Peer network, in another embodiment.

Embodiments of the present invention enable consumers to make conventional and unconventional service requests for everyday or professional services and have these requests fulfilled, by locating experienced service providers and untapped potential. Existing systems have not been seen to address everyday services, specialist or niche services, and or business services in one system. Furthermore, current systems are unable to cater to unique consumer requests efficiently or effectively, due to, but not limited to, the restrictive nature of presentation, organization and preset conventional categories offered, thus restricting discovery, opportunity and growth for those skilled in a, but not limited to, trade, sport, profession, hobby or art. Current systems restrict consumer options resulting in higher prices due to lack of undiscovered competition.

The preferred embodiment promotes flexibility in scheduling service for all users. For example, without limitation, service is conventionally performed during business hours. If a service provider is local and works part time around a full time job, without limitation, evenings and weekends, service can be provided at a more convenient time for the service provider and possibly the consumer, as opposed to official business hours when both parties are more likely to be engaged in their daily profession. This promotes convenience for all, by avoiding untimely appointments during business hours or making special arrangements that could be inconvenient for both the service provider and consumer during the day.

Furthermore, embodiments of the present invention enable consumers to take advantage of skills and prices available only overseas, for pending matters that may be beyond the consumer's financial means in one country, for example, without limitation, specialist health operation or procedure.

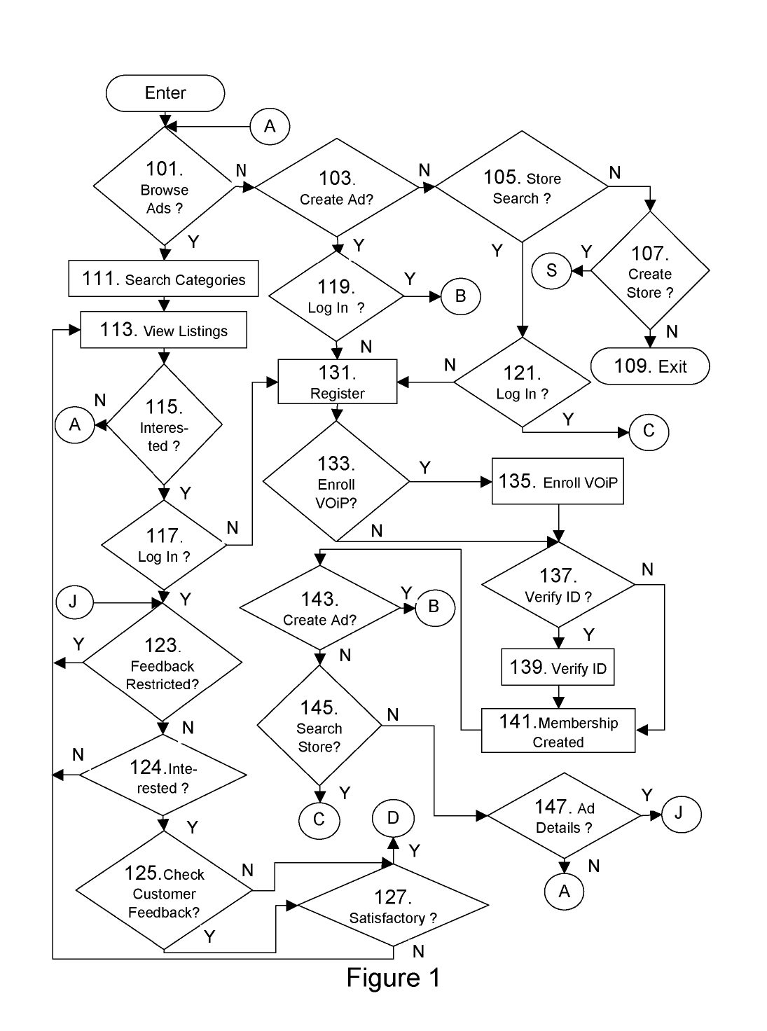

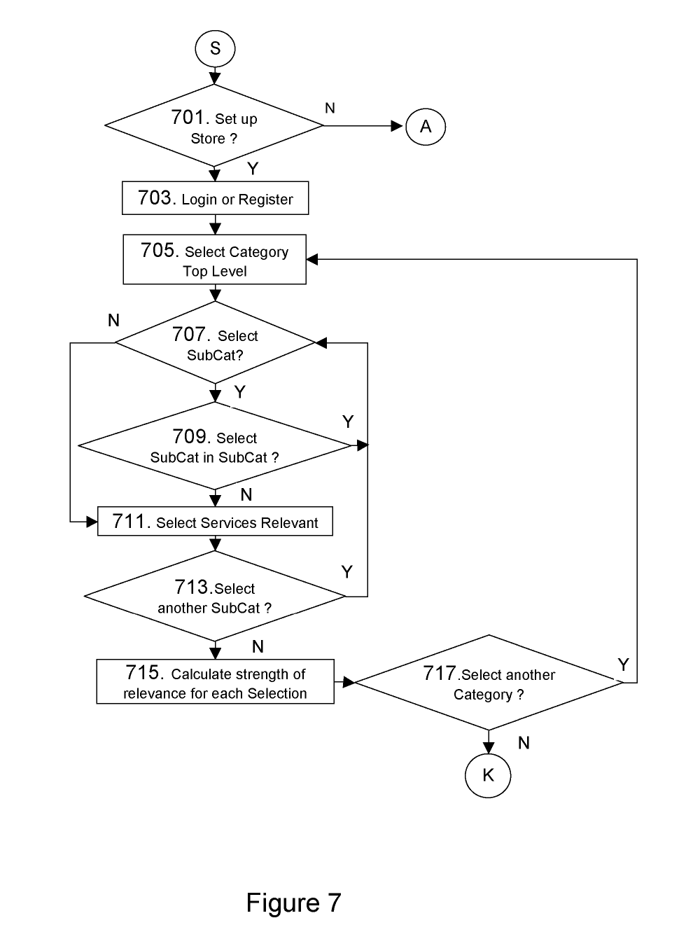

FIG. 1 is a flow chart illustrating an exemplary process for entry and direction of a visitor, of a buyer driven bidding system based on choices made by the visitor, in accordance with an embodiment of the present invention. In the present embodiment, the general flow and sequence of a visitor to the site is dependant on whether the visitor is a consumer, service provider or generally browsing. In the preferred embodiment it is assumed that if a visitor is already registered he can log in at any time, or a new visitor may also register and login by choice at any time, thus eliminating the need to log in again prior to activating a specific process. The present embodiment requests a visitor to log in or register, assuming they have not already done so and are attempting to activate a procedure that requires one to be registered and logged in first. In some embodiments it is possible a visitor may be directed to the home page after registration and log in, or back to the process, requiring log in. It is also assumed in the preferred embodiment a visitor can return to the original point of entry A (home page), or exit the system at any time through self direction (links). Also in the present embodiment, a service may be purchased directly through service stores in a fixed price environment with payment options available on site. The process is entered by a visitor at a starting point A, being the home page, at which time choices are made about the nature of the visitor's use of the system. First, at step 101 the visitor has the option to browse ads on the system. If the visitor decides not to, the system allows the visitor the option to create an ad at step 103. If the visitor decides not to, the system allows the visitor an option to perform a service store search at step 105. If the visitor decides not to, the system provides another option, to create a service store at step 107. If the visitor decides not to at this point, all options are exhausted and the visitor exits the system, step 109. If the visitor does wish to create a store, the system proceeds to a point S, which is the entry point for a method of creating on online store as shown by way of example in FIG. 7.

If at step 101 the visitor opts to browse ads, the system continues to step 111 where the visitor is able to search categories of ads. Visitors browsing ads are typically service providers wishing to bid on service requests. A service provider browses and searches categories of interest from the homepage and drills through consecutive pages into subcategories to locate ads posted, relevant to services in his line of business, skill, art or interest. The depth of subcategories within subcategories is dependent on the nature of the category and clarity required to be as specific as needed in ensuring all relevant services are catered for.

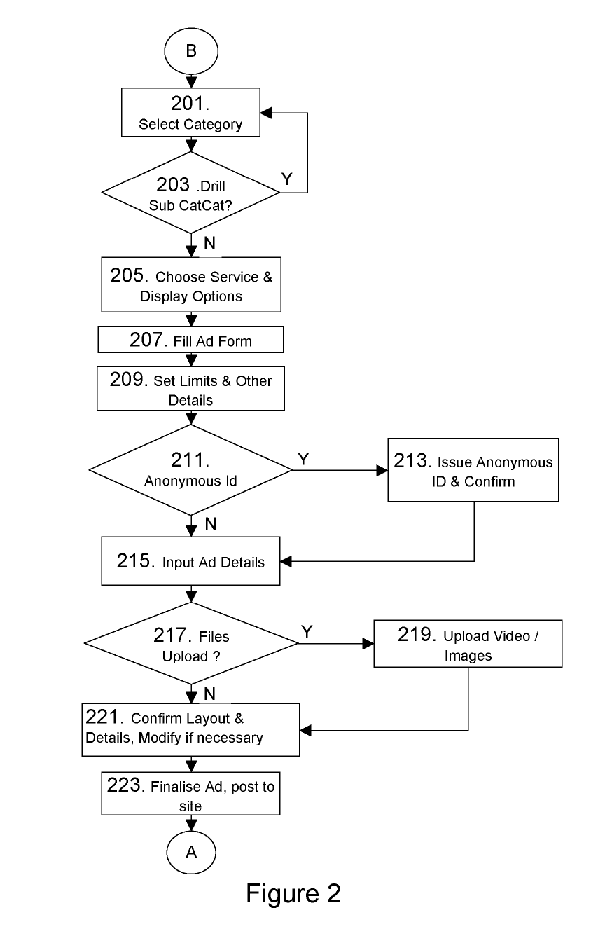

The present embodiment displays tabbed headings representing services relative to each chosen category or subcategory, to potential service providers (bidders). Each tabbed heading further embodies corresponding service options relative to that particular service, within the category or sub category. Service options are made available to consumers during ad creation, as described by way of example in accordance with FIG. 2. Tabbed headings representing services ensures organization, convenience and ease in locating service requests relative to a category or subcategory for a service provider. This approach also generally ensures enhanced exposure of ads to the most relevant service providers in the category, as service providers can locate all types of services being accommodated specific to their category of interest on a single page and view ads of interest by simply clicking on each service tab, which in turn displays listings of ads, relative to the chosen service. The use of service types as tabbed headings relevant to a category for, but not limited to, advertising, displaying, organizing and bidding in this type of environment has not been observed in other applications. The present embodiment is structured to accommodate and grow with the structure of the database through additional categories and services, thus providing broader coverage, detail and further distinguishing services, as opposed to a generalized approach. An increase in services accommodated in any category, results in an increase in service tabs for that category.

Upon clicking a tab all ads are listed in order of date, from the latest going down to the earliest posting, enabling the service provider to view listings in step 113. Listings provide general details about the ad, summarizing information such as, but not limited to, ad title, ad number, number of bids, lowest bid, time left and distance. In the present embodiment, the service provider also has an option to display a map illustrating the location for a single ad, or numerous ads simultaneously. This is achieved by, but not limited to, clicking on a checkbox next to each ad in the listings page, which in turn displays a map with a marker or other visual indicator, representing the location and distance for each ad selected. In the preferred embodiment each marker displays, without limitation, service details of the ad in a balloon upon the mouse being positioned over, or clicked on the marker.

In another embodiment, information displayed in a balloon or similar format includes, without limitation, all or part of, bid details, media files and ad details. Using the mapping display feature, the service provider is able to visually determine Geographic demand relevant to services provided. The service provider can now take advantage of opportunities by optimizing business resources in fulfilling ad requests economically. Visual on screen maps to foresee and target demand geographically and leverage resources accordingly to increase revenue, maximize productivity and bid competitively, is of major advantage to any service provider. Otherwise, one would be required to perform tedious area searches and calculate density and distance of particular service requests, in order avoid mismanaged resources and missed opportunity.

In another embodiment, input in search of service ads include, but not limited to, category and, or subcategory and, or keyword and, or service type and, or location, generating a listing of ads and, or map displaying markers for location and service request details. Service providers can then select ads of interest for further details.

An option to view ads in order of proximity to the service provider is also available in the preferred embodiment, from closest in distance to farthest or vice versa, as a convenience feature and promote efficiency in search. The application calculates, orders and displays distance using the service provider's location details as saved on the system during registration, by default, assuming the service provider is logged in prior to searching ads. In the present embodiment, a service provider also has the option to change his default location within the listings page, for an updated display of ads relative to the new location. In another embodiment a user may input location details for relevant listings, without need of logging in. The present embodiment makes use of a mapping API and, or longitude and latitude values for calculating distance from a service provider to a service location. Input of, but not limited to, a different zip code, postcode or region in order to refine search by proximity to a new location, assists service providers that are able to serve at a local, national or international level. This promotes opportunity to expand business, research and serve new markets, with potential of reducing prices for consumers through increased competition. In the preferred embodiment, ad listings can also be displayed in order of, but not limited to, time left, lowest bid and feedback rating, with results presented in ascending or descending order. Such techniques have been practiced in prior art (forward auctions), although not observed in a reverse auction buyer driven environment, according to embodiments of the present invention.

The service provider decides if he is interested in viewing details on any of the ads within the listing, in step 115. If the visitor is not interested, the system returns to, point A. If the service provider is interested, he must log in or register for membership at this point, step 117.

A visitor wishing to advertise, provide service or search service stores, is required to register, obtain membership and log in, as is standard in prior art. Therefore the visitor is also asked to log on at step 119 if he answers yes at step 103 to create an ad and at step 121 if he answers yes at step 105, to search stores. In some embodiments store search and, or viewing of ad details may not require registration or login by the visitor. Convenience features such as, but not limited to, auto responders and administration of site activity, are available to registered members, these features and the general sequence of a visitor, is standard in an application of this nature, in prior art.

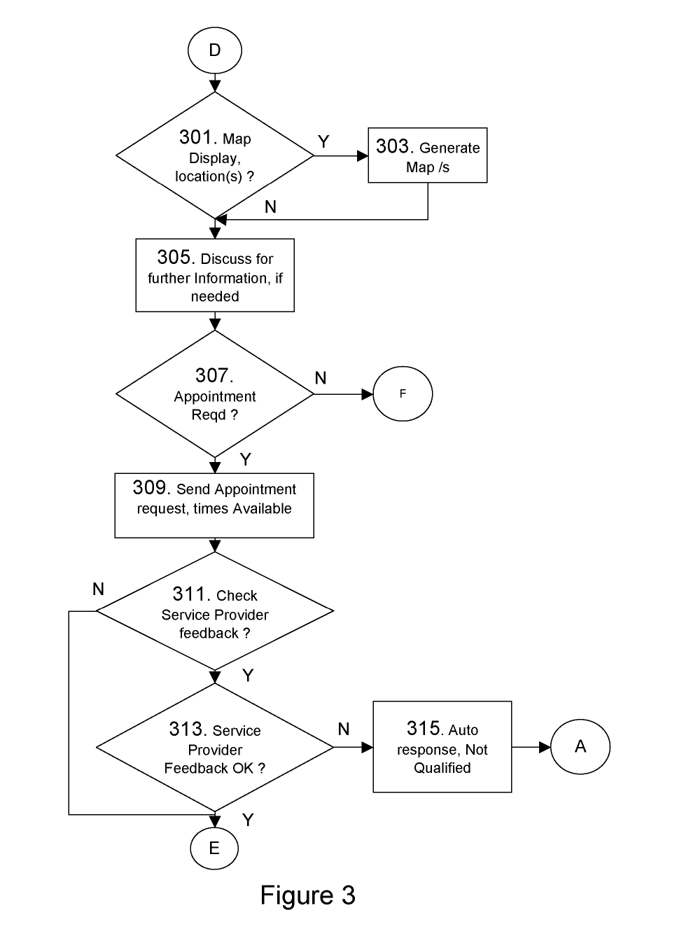

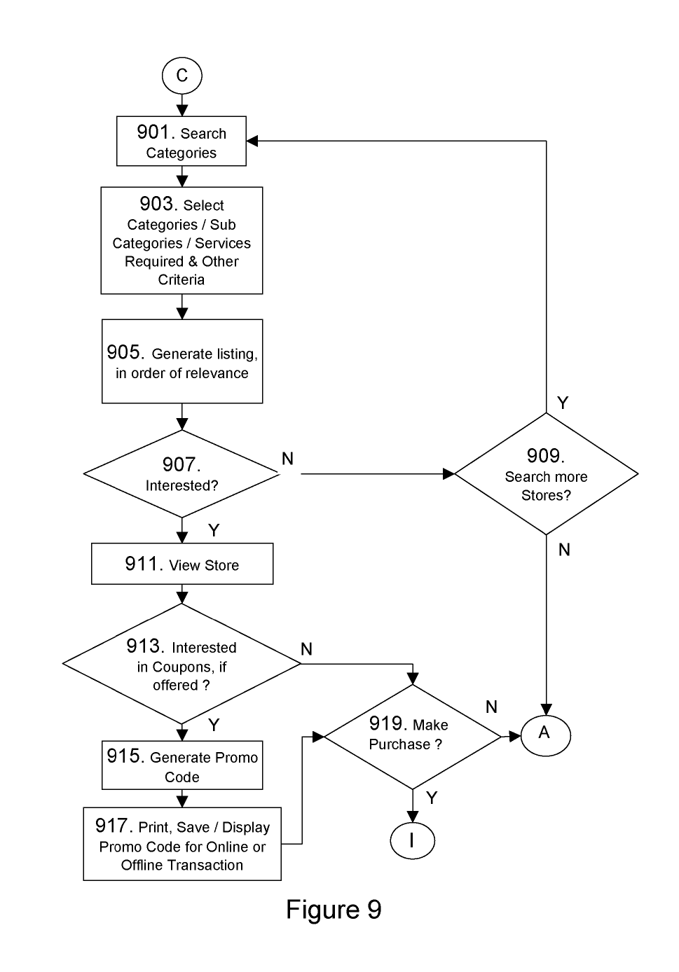

At each of the log on steps, steps 117, 119 and 121, if the visitor is able to log in or is already logged in, the visitor may proceed with the process. If the visitor successfully logs in at step 119, the system continues to a point B, which is the entry point of a process for creating an ad as shown by way of example in FIG. 2. If the visitor successfully logs in at step 121, the system continues to a point C, which is the entry point of a process for performing a store search as shown by way of example in FIG. 9. If the service provider successfully logs in or is already logged in at step 117, prior to displaying ad details, the system checks for any restrictions in minimum feedback ratings that may have been imposed by the consumer advertising for service, in step 123. If there are restrictions that the service provider does not meet, the service provider is denied from accessing the particular ad and the system returns to step 113 so the service provider can view more listings. If there are no restrictions, the system continues to step 124 where the service provider reviews ad details including, but not limited to, images, video, audio, text or any other technology or method used in creating the service ad. Upon review he decides whether he is still interested, if not the system returns to step 113. If still interested the service provider proceeds to step 125, where he decides if he wishes to view customer feedback. Each listing displays a members ID with feedback rating as a link, which can be investigated for feedback details and history, unless a consumer has opted to maintain anonymity in which case only the feedback rating is displayed, as a static reference without access to detail. If feedback is accessible and the service provider wishes to view customer feedback, the system proceeds to step 127, an investigation at this point enables the service provider to determine if the consumer is compatible. In the present embodiment, this comprises a page displaying, but not limited to, comments and ratings received reflecting past experiences, service providers have had with this particular consumer. If the feedback is satisfactory, the system continues to point D, which is the entry point of a process for a service provider to respond to an ad as shown by way of example in FIG. 3. If feedback is unsatisfactory, the system returns to step 113, allowing the service provider to continue viewing listings. If the service provider does not wish to view customer feedback, or it is inaccessible at step 125 and he is still interested in the ad, the system proceeds directly to point D. In another embodiment, feedback may be unavailable for a consumer.

If at any of the log on steps, steps 117, 119 and 121, the visitor cannot successfully log on or is not already logged on, the system proceeds to a membership creation process beginning with registration at step 131, assuming he is not a registered member. It is understood the present embodiment caters for the retrieval of forgotten user ID and password during log in, for registered members, as is standard in prior art. At the registration step, step 131, the visitor is asked to enter various types of identifying information such as, but not limited to, name, address, company name, security questions, etc, as is standard in prior art. In some embodiments, the information requested at step 131 varies depending on whether the visitor is a consumer or a service provider and, or of a particular type. In the present embodiment at step 133, the visitor can decide if he would like to have his ID enrolled in VoIP (Voice over Internet Protocol) online communication, meaning the visitor has the necessary hardware to connect and converse online. If the visitor enrolls in VoIP, the visitor can connect to, receive invitation to and initiate a voice enabled conversation (VoIP) without a telephone number, instead with a mouthpiece for input and speakers for output, or other device connected to the system. Enrollment performs set up and ensures communication features function properly with existing components and or third party components. In some embodiments communication includes, without limitation, video, text and audio (VoIP), with enrollment and setup being performed during connection. In the preferred embodiment a member can activate online presence, through, but not limited to a simple check box, or clicking of an icon after log in. The system allows activation, without limitation, in initiating communication by clicking on another member's ID or icon, if their ID/icon indicates that they are online at the same time. This enables members to converse online knowing the other party is present at the same time unless a user decides to block another from contact, or deactivates communication for privacy. This saves time in locating and ensuring contact is made directly, in privacy with the right person at a mutually convenient time, reducing the need to disclose telephone numbers, leave messages or go through a third person. Using VoIP technology, all parties can communicate and discuss service requirements and transactions, prior to engaging service and during service. This technology has been around for some time but has not been seen implemented in a similar online buyer driven environment. If the visitor wishes to enroll in VoIP at step 133, the system enrolls the visitor into VoIP at step 135 then proceeds to step 137. If the visitor does not wish to enroll in VoIP, the system proceeds directly to step 137, providing the option to verify the visitor's ID.

The preferred embodiment provides the option to have a member's ID verified, as well as verification of professional licenses and memberships, for example, without limitation, contractor or instructor, where relevant. Member IDs are verified through an external third party service, or online authorities. License details are required during registration, for those service providers that opt for license verification, to confirm and verify details with relevant authorities, either online, third party or via direct contact. Symbols or other forms of enhancement are implemented depicting verification and are displayed or incorporated with the member's chosen ID, to enhance credibility, trust and confidence in the bidding environment. All personal information pertaining to registration and license details is encrypted and secured as appropriate and necessary, to protect members, as is standard in most web applications. Verification or certification of a professional licensed service provider has not been seen in a consumer driven service environment of this type. Verification gives the buyer the option to evaluate a bidder on professional credentials and feedback against other service providers, instead of feedback and, or ID confirmation alone, prior to determining a winning bidder. External services that provide verification of age and identity only, as implemented in prior art, have no relativity in assisting or assuring a member, regarding service or viability of another member, except that the members ID is confirmed. In some embodiments the option of verification, may not be available or in other alternative embodiments verification may be limited to service providers only. If the visitor opts to have his ID verified at step 137, the visitor's ID is verified at step 139, and the system proceeds to step 141. If the visitor's ID is not to be verified, the system proceeds to step 141 where a membership is created for the visitor. After the membership is created and the visitor is logged in, the system returns to the initial process that required the visitor to log in and proceeds on from that point. At step 143, if the visitor was in the process of creating an ad the system returns to point B. Otherwise the system proceeds to step 145, where if the visitor was in the process of searching a store, the system returns to point C. Otherwise the system proceeds to step 147, where if the visitor was in the process of accessing an ads details the system would return to point J, otherwise it would return to point A, being the home page. In alternative embodiments, after creation of membership, control would then return to the point in process, that required the visitor to be logged in, where the visitor would then have to log in before the process continued.

In the present embodiment, a member's ID is displayed as appropriate throughout the site, relevant to ads, bids, etc with feedback accessible unless anonymity elected. A member can also block certain ID's from contact or bidding on their service ad, if need be from within member services. For example, without limitation, a user may want to do this in order to avoid certain members known to them. These are all standard features known to those skilled in the art and available to members in most web sites of similar nature.

FIG. 2 is a flow chart illustrating an exemplary process for a consumer to create an ad for a desired service in a buyer driven bidding system, in accordance with an embodiment of the present invention. Typically, to advertise a consumer logs in to the system, step 119 in FIG. 1, and then enters the ad creation process at point B. In the present embodiment, the consumer first chooses the main, or parent, category of interest at step 201, selection of each category subsequently displays further subcategories at step 203, relevant to the category chosen in step 201. The system will continue to display subcategories upon selection of any subcategory without limitation, to accommodate demand in service specificity. The process of choosing a subcategory within a subcategory relevant to the consumers service need continues, between steps 201 and 203, until a consumer is satisfied the level of depth of the chosen category or subcategory is adequate for clarity, logical convenience and as specific as necessary in placing the advertisement.

In step 205 the consumer chooses a service option for the ad. Each category or subcategory chosen displays a series of service options relevant to that chosen category or subcategory, only. For example, without limitation, a main category of entertainment may have a subcategory of music, which may have a further subcategory of rock and the service options band, singer, DJ, and lessons. In another non-limiting example a main category, food & beverage may have a sub category of Indian and service options of, catering and lessons.

The service options may also be the same for two categories or subcategories if both are similar in their respective services. For example, without limitation, pop and rock may both be subcategories of music and both may offer the same service options, as they are both similar in services relative to each. This following non-limiting example illustrates the depth and relationship of categories, with ‘Car’ being a subcategory of the main category ‘Automobile’, and the service options that are made available to different subcategories, within. In this case, a subcategory of ‘car’ contains a further subcategory of ‘type’. The subcategory of ‘type’ may be further broken down by ‘make’, of car, with the ‘make’ now becoming a subcategory, of the subcategory type of car, if desired. To illustrate, a main category of automotive has a subcategory of car with service options of lease, rent, insurance, lessons, clean, design, repair, etc. The subcategory of car has further subcategories of (type), classic, family, convertible and sports. Selecting the type of car as convertible would further display subcategories of (make) Ford, Toyota, Ferrari, BMW, depending on if those makes are relevant to convertible, with service options of lease, rent, insurance, design, restore, paint, engine, suspension, etc. In the prior example it is possible subcategories ‘car’, ‘type’ and ‘make’ may have the same service options, this leaves the consumer to decide, what level of category depth is required for advertising, to satisfy their service need, being as specific as necessary. Another exemplary subcategory of the main category automotive and subcategory car may be professional sports, with a further subcategory of dragster and service options of lease, rent, insurance, design, restore, paint, engine, suspension, wheels, parachute, etc.

Sub categories are unlimited in depth in order to ensure the most detailed of requests can be satisfied. This generally ensures an organized and efficient environment is maintained for advertising service requests and ease for service providers in locating service ads of interest and, or specificity. Adopting a top-level category approach, without a detailed break down would make it difficult to ensure an ad is viewed by the most apt service providers and, or receives the most optimum bids.

Further non-limiting examples of categories and subcategories are as follows. For example, without limitation, a category of health may have a subcategory of dental with service options of check up, pediatric, orthodontic/braces, implant, crowns, dentures, bridges, etc. Another subcategory of health may be heart with a service option of surgery. Another subcategory of health may be eyes with the service options, optician, glasses, surgery, laser, etc, As illustrated a broad structure could also be adopted at subcategory level, as opposed to depth, as in prior example. In the preferred embodiment integration of both are implemented to accommodate as necessary.

In the present embodiment, after choosing a service option(s) in step 205 a consumer then selects a design layout for the ad, choices are, but not limited to, video, images, audio, text, or combination thereof, depending on what the consumer would like to use in enhancing the clarity of the service request. A form is then displayed on the following page to obtain, but not limited to, an ad description, media files and pertinent information, necessary to generally ensure relevant details are posted, for a service provider to make an educated bid. The consumer fills in this form at step 207. Questions on the form are short, limited and relative to the category, subcategory and chosen service option, only. Answers can be provided by the consumer in various forms such as, but not limited to, text, checkbox, radio button, dropdown list, etc. for convenience and efficiency. For example, without limitation, in the previous car example, if a consumer drilled down to the subcategory dragster and chose a service option of suspension, questions relative may be, front, rear, height, car weight, fitting required, required by, etc, or for the service option engine, questions may be, BHP Required, fitting, size, weight restrictions, etc. In many practical applications, this tends to promote efficiency in constructive bidding, as there is less time wasted in obtaining pertinent details relevant to the service option chosen. The questions also narrow down and filter responses from service providers that can deliver on strict requirements, as opposed to time wasters. Thus achieving the goal of obtaining bids from the most optimum service providers. In another embodiment questions maybe as extensive as need be, to ensure all details are covered in depth.

All categories, subcategories, service options and questions are created through an administration panel, with the flexibility to add to the existing database structure and present information accordingly. In depth research is required on an ongoing basis to accommodate ever-changing markets and generally ensure categories, subcategories, service options and questions accommodate the widest array of services globally, with logic and relativity. Some embodiments may include options for the consumer to make his own categories or subcategories for service requests that are out of the ordinary.

Another non-limiting example of questions on the form in step 207 is for a category of health, with a subcategory of dental and service option of crown. For crowns a dental surgeon would want to know information such as, but not limited to, which tooth (the page may display an image on which an indication could be made), material (gold, etc), x-ray available, etc. A consumer can indicate if the answer is not known, in which case, further contact can be made for clarification using means such as, but not limited to, VoIP, email or internal messaging. This further enables a consumer to avoid exuberant consultation fees and unexpected surprises, by knowing how much treatment will actually be required, prior to appointment in this particular case.

Further non-limiting examples of questions that may be asked of the consumer about the service desired follow. If a quote is required for insurance on a house, information required on the form may include, without limitation, value, zip code, number of bedrooms, smoke detector, alarm, security etc., in order for interested service providers to bid accurately. Or, a request for transportation of a particular product, the service provider may require information such as, but not limited to, dimensions of product, weight, special handling instructions, destination and pick up information, etc. This ensures necessary details are posted with ad, reducing possibility of any confusion. In this example, a service provider (transportation co.) may bid on a consignment or load for delivery that may be on their route in any case, for which a consumer could receive a very competitive quote and establish a new relationship.

The following are non-limiting examples of requests that could not easily be organized within other systems for efficient location by interested service providers, due to limitations in service categories, presentation of ads, structure, organization and or bidding restricted to conventional business's or service providers, only. Restoring an antique watch, insuring a specialist product, flying lessons, car oil change, lesson in traditional Indian dance, aircraft refueling business service, learning to cook Lebanese cuisine, insuring shoes, electrolysis for beard line, obtaining a patent application, dental work, learning to play a traditional instrument, testing insecticide, surgical procedures, training a pet, excavation/drilling, etc. Although many of the aforementioned requests may sound peculiar, unrelated or unusual, it is an example to illustrate the wide spectrum of services that embodiments of the present invention can accommodate, through the particular organization and structure adopted, this generally ensures the right service providers are matched with relevant requests efficiently and accurately. Many requests are unconventional or specialist and can only be fulfilled by members of the general community, for this reason, embodiments of the present invention are not restricted to conventional businesses or professionals only. These embodiments promote and encourage minority or new service providers, or those with unique skills to promote themselves and exploit skills to fill voids in customer demand, thus developing new markets and business opportunities.

Other options in posting an ad in the preferred embodiment, enable the consumer to specify restrictions to filter unwanted bids, these include, without limitation, a minimum feedback rating, location of service provider, location of service required and stipulation of time and, or date for when service is required and, or to be completed. A consumer also has the option to specify the date and duration for ad listing and or, the preferred currency in bidding. Selection of preferred currency provides greater control and flexibility in advertising internationally, through global service providers being familiar and comfortable with established, recognized currencies, for example, but not limited to, US Dollar, Euro and Japanese Yen. Certain options are known in prior art, but have not been observed in a buyer driven service oriented system, of this nature. In the present embodiment the consumer can set these limitations in step 209. By blocking or restricting service providers, unable to meet certain criteria from bidding, the present embodiment enables meticulous consumers the flexibility to narrow bidders and ultimately save time, by ensuring only those that meet the specifics of the service required, submit a bid.

In step 211 a consumer can also opt to hide their membership ID in a service ad for privacy reasons, in which case a request to the system is made, which in turn generates and returns an anonymous ID/icon, that is displayed for the duration of the ad post, in step 213. Confirmation of the anonymous ID is sent to the consumer via internal messaging or others means without limitation, in step 213. When posted the ad displays an anonymous ID/icon and the actual feedback rating associated with that consumer, as static reference. A consumer has the choice of disclosing their actual ID at any time, to any single service provider through, but not limited to, internal messaging or ad options available in their personal account, on the system.

In the case of an anonymous ID a service provider is unable to view a consumer's feedback history in any detail, however he is aware of the rating as displayed and able to make a preliminary assessment of viability, prior to bidding. Some embodiments may disclose feedback history without revelation of true ID, of an anonymous advertiser, to promote confidence in a service provider. In the preferred embodiment, communication can still be active if there is a need to discuss service requirements, without out the need to disclose identity. Methods of communication include, but are not limited to, internal messaging, email, chat and VoIP. This provides the consumer with a degree of privacy and credibility in posting ads without disclosure of ID and enables a consumer to request bids and discuss service with new service providers, without the possibility of offending an existing service provider. Prior solutions have not accommodated an option to disclose or maintain anonymity during advertising and allow active communication at the same time, thus restricting a buyer driven environment, of this type. Once all options and limits, etc have been selected the consumer now describes the service required at step 215, with details of exactly what is required and expected, in the service selected. In alternative embodiments the various steps pertaining to creating an ad, but not limited to category selection, details and options as described in steps 201-211, can be in any sequence without need to adhere to a specific sequence.

The process then continues to step 217, to determine if there are any, but not limited to, files or ad content to upload or give direction to, if so the process moves to step 219, otherwise control moves to step 221. The consumer may upload or direct to content such as, but not limited to, video, images, and audio in step 219, in helping describe the needs and scope of the service request. In another embodiment, the system facilitates other media, format or technology through incorporation of, or external link to, third party applications or technology, to enhance the ad and or user experience. Once files, etc are uploaded and or incorporated, the system proceeds to step 221 where ad details are presented for preview, within the ad layout design previously selected. Layout designs used for displaying information and enhancing images, text and ad specifics are standard in prior art, product oriented systems, but not been observed in a buyer driven, service oriented environment as described. In an alternative embodiment, presentation of ad details and uploaded content defaults to a standard design layout, with no other choice. Or in another embodiment, design for ad layout is determined by category and or type of service selected. Ad information presented includes, without limitation, answers to questions regarding selected category, subcategory, service option, any preferred restrictions, duration of ad, location, consumer contact options, bid details, textual description, images, video, audio and any other information relative to the ad. All uploaded content can be displayed and played from within the listing preview page, giving a consumer complete control to perform functions such as, but not limited to, stopping, pausing, playing, etc. The layout and all information within the ad can be edited at this point, before the ad is finalized and posted to website in step 223. In another embodiment a consumer maybe required to navigate back and fourth between pages to implement changes. Further in another embodiment, a consumer could create and save the ad, to be recalled at a later date for posting. Once the ad is saved and posted, the system returns to point A, shown by way of example in FIG. 1.

Video and audio has been adopted in the present embodiment, as images alone do not always suffice in conveying a service request clearly. In many situations, the only way a consumer can confidently convey requirements and service needs to a service provider in order to receive an accurate quote, is through an appointment to visit the site requiring service, for example, for services such as, but not limited to, landscaping, building work, store front glass replacement, a leaking commercial freezer or roof repair. Hence the importance and advantage of video and audio, which in many instances is able to satisfy and accommodate a visual interpretation or explanation of service needs, thus promoting convenience for all. Video and audio, also allows for an overall view of the environment of service need, exposing external factors that may influence an accurate quote, thus avoiding unforeseen circumstances or confusion later. A video of the site in cases such as, but not limited to the aforementioned, may enable the service provider to submit a bid without need of physically viewing the site.

Using video enhances clarity in describing service needs, reduces a need for appointments and enables service providers to bid accurately, saving time for all parties. Using video also promotes privacy, comfort and safety for consumers by avoiding the need to have strangers visit premises to view service needs. Video has accommodated the sale and promotion of products in prior art, whether buyer driven or seller driven, however video is particularly useful for service requests, as much of the time service requests can be intangible, and difficult to describe or imagine without live visual aid.

A means of displaying greater detail and description is required in the present embodiment, due to the vast number and types of services for which this system caters. In most cases just words and images alone cannot convey the needs of the consumer, accurately. A lack of information in clearly presenting the service need at hand can compromise quality in service, price and expectation. It is much easier for a service provider to assess by viewing a video clip or images with audio explaining the task at hand, as opposed to a textual description and images only, in certain cases. Use of, but not limited to, video, images and audio in a buyer driven environment as described in the present embodiment, has not been observed in prior art.

FIG. 3 is a flow chart illustrating an exemplary process for a service provider to respond to an ad for a service request in a buyer driven bidding system, in accordance with an embodiment of the present invention. A service providers response process begins at point D. The service provider has the option to display a map within the ad details, similar to that available in the ad listings page, depicting location of the service request, in step 301. If the service provider does wish to view a map, this is achieved in step 303 through integration with a mapping API, displaying a marker pin pointing the location, with information including, but not limited to, name/title, distance and details of the service request. The mapping API can also facilitate route and direction information to service ad locations, for those that require it.

The service provider also has the opportunity to discuss requirements online through means such as, but not limited to, email, private message board, chat, live video link, or VoIP (Voice over Internet Protocol) in step 305. In the present embodiment, an icon highlighting the online presence of a member is displayed, as a link to, without limitation, activate and invite conversation or video link for all respective members. VoIP and video link saves time and money by reducing the need to make phone calls and avoid inconveniences such as, but not limited to, missed calls or time spent locating correct party, etc. thus promoting convenience and comfort in communication for all through simultaneous online presence. Live video link also promotes flexibility in evaluating a service request reducing appointment needs, as a service provider can direct a consumer to focus a video camera on abstract aspects of a service request, to obtain a live controlled interpretation. For example, a consumer requiring building work could be directed to focus on particular details or the surrounding environment, in order for a service provider to review restrictions or other aspects that may not be apparent otherwise.

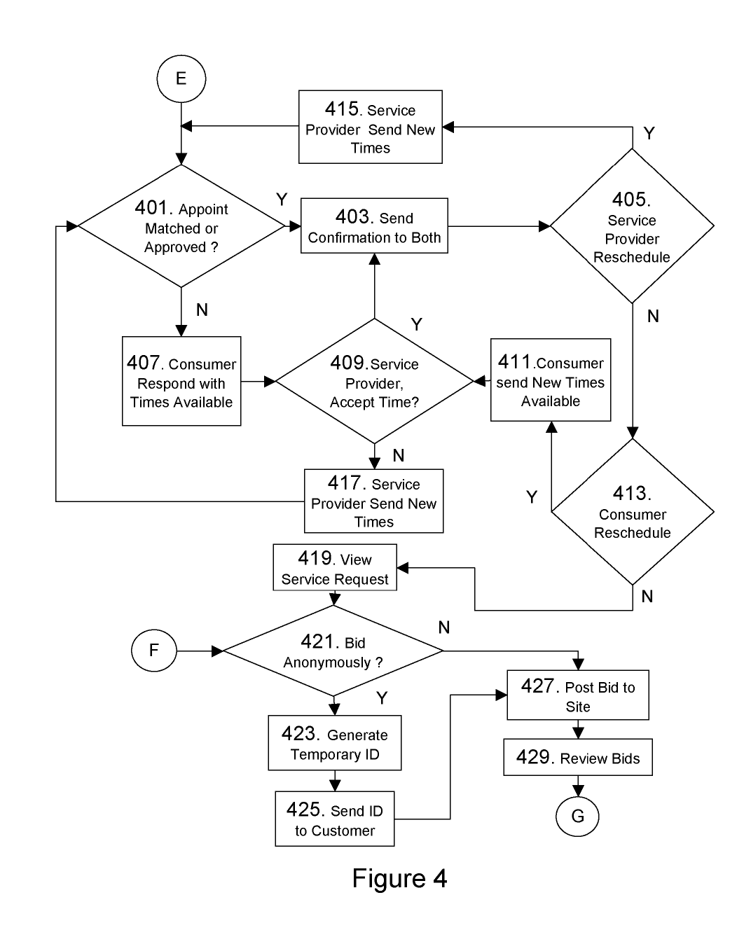

If the ad is of interest, but requires further clarification the service provider has the option to request an appointment, prior to bidding at step 307. If no appointment is required, the system proceeds to a point F at which point the bid process continues, as shown by way of example in FIG. 4. Appointments may be required for service requests where, without limitation, video, audio, images and conversation do not satisfy a confident bid. The process of setting up an appointment is generally an automated procedure that can be initiated and confirmed online, this reduces time spent, but not limited to, making phone calls, locating the correct person or waiting for confirmation on appointment times, etc, thus making appointment requests easier and more efficient. In the present embodiment, an appointment diary with details such as, but not limited to, requests, confirmation, dates, locations, pending and past appointments, etc. is incorporated for each member and accessible within their account, when logged in. All members can use their individual diary to accommodate personal timetables. In the case of a service provider requesting an appointment, the service provider accesses his online diary and selects dates, times, etc. of when he is available to view a service request. Appointment times requested are then sent to the consumer for confirmation in step 309. When the requested appointment times are received, the system informs the consumer of the appointment request. The consumer now has the option to check prior feedback for the service provider requesting the appointment at step 311, in order to determine whether or not to grant an appointment based on the qualifications and history of the service provider. If the consumer decides to review feedback, the process moves to step 313 where the consumer determines if the service provider is suitable for the service need. If the service provider is suitable, or the consumer chooses not to check the service provider's feedback in step 311, the system proceeds to a point E, which is the entry point into an appointment system shown by way of example in FIG. 4. Otherwise, if after review of feedback in step 313, a service provider is deemed unsuitable, an automated message is sent notifying the service provider, of services not required in step 315, and the system returns to point A, as shown in FIG. 1. In another embodiment a consumer could cancel an appointment request, through options available in appointment diary, as indication of services not required. The service provider would then be notified accordingly, through but not limited to, update in appointment diary, email, internal message, etc. a. FIG. 4 is a flow chart illustrating an exemplary appointment system of a buyer driven service bid system, in accordance with an embodiment of the present invention. In the present embodiment, the appointment system begins at point E. The system attempts to match appointment times received from the service provider, with a consumer's diary, for preset dates and times of availability if input, or acquire manual approval from consumer, in step 401. If there is a suitable automated match, or the appointment is manually approved by consumer, both parties are sent confirmation via means such as, but not limited to, updated status of appointment in diary, internal messaging or email in step 403. If there are no suitable times in step 401, the consumer may respond with available dates and times to reschedule, in step 407, the new times are then sent to the service provider for approval in step 409. If the consumer's rescheduled appointment is successfully matched against preset dates and times of availability, or manually accepted by service provider, confirmation is sent to both parties, in step 403. If appointment match or approval is unsuccessful, the service provider may reschedule with new dates and times, at step 417, in which case the process continues as before, attempting to match or approve appointments with consumer, at step 401. The system offers flexibility in rescheduling a confirmed appointment, after being accepted and conveyed to both parties, at step 403, should the need arise. If, in step 405, the service provider objects to a previously confirmed appointment, he can reschedule and send new times for the appointment in step 415. As previously, for new times received, the system attempts to match times with the consumer's preset times of availability or obtain manual approval, in step 401. If no objections are made at step 405, the process moves to step 413, where the consumer has an opportunity to reschedule a confirmed appointment. If there is a need to reschedule, the consumer inputs new times in step 411, and an automated match against preset availability or manual approval is attempted with the service provider, in step 409. The process then continues in the cycle previously described, as determined by choices made and outcome of appointment match or approval. Either party may reschedule or cancel an appointment at any given time, which in turn determines the flow of application without limitation, each course of action taken ultimately works towards an agreeable appointment time or advancement without appointment.

This process serves as a time saving convenience feature as either party can predefine multiple times of availability with preference. The system then matches appointment times with availability prioritizing preference, and sends out confirmation to both parties in absence of all concerned, resulting in an automated process and reduced need in the two parties having to be available at the same time to, but not limited to, make verbal contact, initiate, confirm, cancel or change appointments, etc. In the present embodiment, each member's diary maintains the status of all appointments past and present, with times of availability, etc. After both parties agree on an appointment time, the service provider views the service request, in step 419.

In another embodiment, the appointment procedure would be a straight forward back and forth manual process between consumer and service provider, until both mutually agree on an appointment time from options offered by either party, without automation or matching of pre selected availability. Control and organization is maintained within each member's diary, with options to include, but not limited to, input of dates and times, request, reschedule, confirm and cancel, with the status of the appointment being updated accordingly for each member. Further in another embodiment, the appointment system would be fully automated as described in matching appointments, without option of manual intervention.

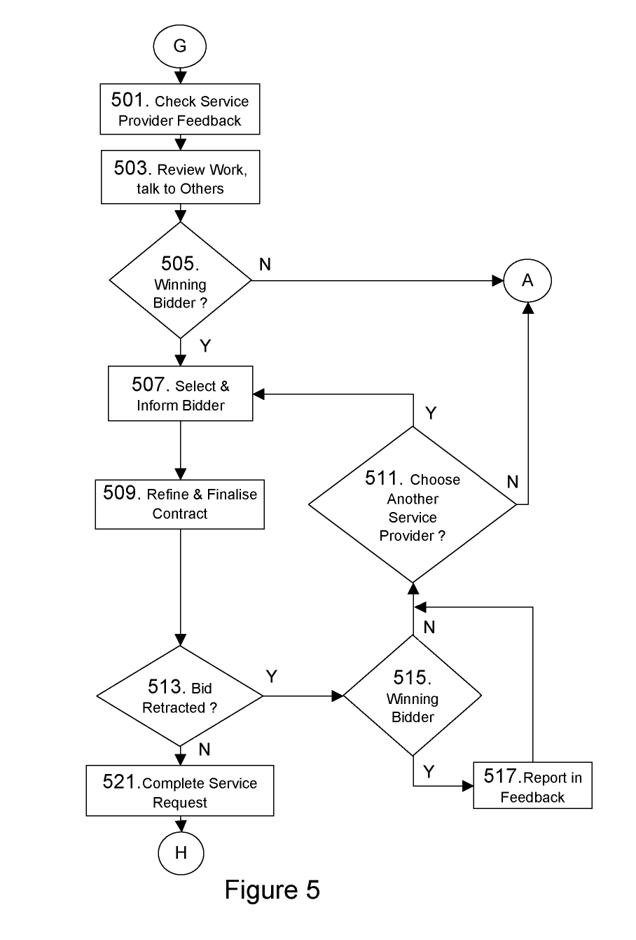

a. Conventional methods of arranging and confirming appointments include, but not limited to, telephone and notations this can be time consuming and prone to error. The need for an appointment system has been limited in prior solutions due to most online systems catering to product sales, whereby a need for an appointment to view is unnecessary in most cases. Or in the case of intangible services where all work can be bid, completed, viewed and tracked online without a need for an appointment, as physical presence is typically not required. The present embodiment accommodates all types of services and attempts to satisfy accuracy in service description via means such as, but not limited to, video, audio, images, VoIP. However, there may be occasions when a service provider's viewing is necessary hence the need for an appointment system. Prior to bidding, regardless of an appointment, the service provider has the choice of bidding anonymously for privacy reasons in step 421, or proceeding on to bid normally displaying ID, in step 427. If anonymity is desired, an anonymous ID is requested from the server, in step 423. Temporary ID's are issued for the duration of the ad/bidding and erased there after. Each anonymous service provider ID generated is disclosed to the consumer via, but not limited to, internal messaging, email or update in account, with the true ID of the bidder, in step 425. Upon disclosing the true ID to the consumer, the service provider is able to post a bid using the anonymous ID, at step 427. As bids are received from various service providers, all bid activity is displayed and viewable to all, the consumer then reviews bids in step 429. The system then proceeds to a point G, which is the entry point to an exemplary decision procedure for a consumer, shown by way of example in FIG. 5.

b. In another embodiment, disclosure of anonymous ID would be instantly made upon submission of bid and displayed in disclosed bid activity, accessible to consumer only, within their account. Or, in another embodiment no temporary/anonymous ID would actually be generated, instead a generic icon would display in all undisclosed bid activity, for each service provider desiring to remain anonymous, with disclosure of true ID displayed in disclosed bid activity, accessible to consumer only, for each respective bid.

Anonymous bidding enables the service provider to maintain privacy from competitors, without limitation, in pricing structures or resources available, and to experiment in new markets without alarming existing competition, whilst maintaining transparency and confidence with the consumer, in a competitive bidding environment. The present embodiment enables a consumer to identify and investigate an anonymous service provider, whilst allowing the service provider to maintain anonymity between all competing service providers. This enables the consumer to confirm viability of a service provider before entering into any further discussion or agreements. Anonymous bidding with disclosure of ID to the consumer only, in a buyer driven environment has not been observed in prior solutions. Prior solutions serving a similar purpose include sealed bids or communicating offers by email. However, this type of nondisclosure between competing service providers restricts competition and can result in a mismatched relationship, for example, without limitation, a less competent service provider willing to quote for less, increases risk for the consumer.

FIG. 5 is a flow chart illustrating an exemplary process for a consumer to choose a service provider in a buyer driven bidding system, in accordance with an embodiment of the present invention. In the present embodiment, the decision process begins at point G. Feedback and ratings of service providers submitting bids, is reviewed in step 501. Information consists of, but not limited to, comments, audio, video, images and ratings in consumer satisfaction, for individual service requests. Ratings may be viewed specific to service attributes such as, but not limited to, quality, skill, time, accuracy, knowledge, etc. displaying each relative completed service request, or as an accumulation of attributes in services, completed to date. Ratings, specific to elements of service can be invaluable to a consumer, as this provides greater clarity in strengths and weaknesses relative to each service provider. For example, without limitation, a service provider who performs quality work at a decent price may constantly have a low ranking for timing in which case it maybe a better choice for a particular consumer to choose another service provider that maybe more costly, but rated well on adherence to schedule, if time is of priority. Service attributes form to create a pattern of a service provider's key qualities, allowing a consumer to make comparisons and decisions prioritizing those qualities that are of personal importance or preference to them.

A consumer can also take this opportunity to view video or images posted, reflecting ratings as a point of reference and, or view of a service providers past work. Video serves to justify feedback from past consumers, or in an alternative embodiment, assist service providers in promoting past work. If a prior consumer has left their ID open for contact, a prospective consumer can contact them using means such as, but not limited to, VoIP, messaging or email, with questions regarding experience with the service provider in question, in step 503. Using VoIP, a consumer can contact another consumer instantly if they are both online at the same time and ask questions live in person. This saves time, promotes confidence and provides an objective assessment of the service provider, especially when there is need for an urgent decision. As time for the posted service request nears expiry, the consumer makes a choice and decides on a winning bidder in step 505. If there is no suitable bidder, the system returns to point A, allowing the consumer to re advertise the service requirement, if need be. Otherwise the winning bidder is selected and notified, in step 507 via, but not limited to, indication on site, update in member's account, or email.

In a variation of prior art, price could be determined by the consumer, through submission of own price for a service required, with the choice of providing service at the desired price, at the discretion of service provider. This may be feasible depending on the type of services required, for example, without limitation, designers, programmers, etc., where individuals or companies may offer service at known international hourly, or standard country specific rates. A consumer may also approximate cost based on similar requests of completed service. However, this method of determining price is not practical for the vast majority of services being handled by many embodiments of the present invention, due to factors such as, but not limited to, ever changing rates in materials, labor, experience, ranges in quality, locality, etc. Furthermore, this approach would typically compromise the objective of locating the most optimized service provider for a service need.

In the present embodiment, the winning service provider and consumer, discuss, arrange and finalize service contracts/agreements, in step 509. The process then continues to step 513, if the service provider retracts his bid at this point, the system proceeds to step 515, otherwise service is completed at step 521. At step 515, the system performs a check to confirm whether this is the first selected winning bidder, if so an indication of bid retraction is made in the service provider's feedback ratings in step 517, with no other feedback for the service request. This acts as a warning to future consumers that this particular service provider may not be a serious bidder, which can compromise reputation. Upon processing of bid retraction, the system proceeds to step 511, where a consumer has the option to choose a different service provider, via return to step 507 and repeat the process, or return to point A, being the home page, where the consumer may re advertise the service request, if need be. In the present embodiment, only the original winner can be reported for bid retraction in one single ad, as the others bidders did not win and are not obligated to provide service. As there are no financial penalties, the method of reporting a service provider for retracting bids, acts as a deterrent and generally ensures that bids are placed with the serious intention of providing service. It is also possible that a potential winner or a consumer's second choice may no longer be available to provide service, upon later selection, for this reason a penalty of some degree is desirable. Financial penalty is another option in some embodiments; however, this may inhibit service providers from participating, leading to limitations in the system. In another embodiment the system would operate without means of reporting or penalty for bid retraction, simply allowing a consumer to choose another service provider.

The system according to the present embodiment provides greater flexibility and freedom than prior art systems, as it facilitates on-site transactions as well as allowing for transactions and communication between buyers and sellers to take place off the website in an open environment, if opted for. Other systems require onsite messaging and monetary exchange in order to track sales for commission purposes. The present embodiment also promotes a pressure free environment for all members as there are no binding contracts or financial penalties for retracting bids. Imposition of legally binding contracts in prior solutions can limit potential service providers from participating and can be considered a deterrent. The present embodiment focuses on securing integrity for buyers and sellers, protecting all members and weeding out the minority risk, without binding contracts or financial penalties. In an alternative embodiment, all communication and activity would be restricted to on site, and for the system to govern transactions and enforce policies, accordingly.

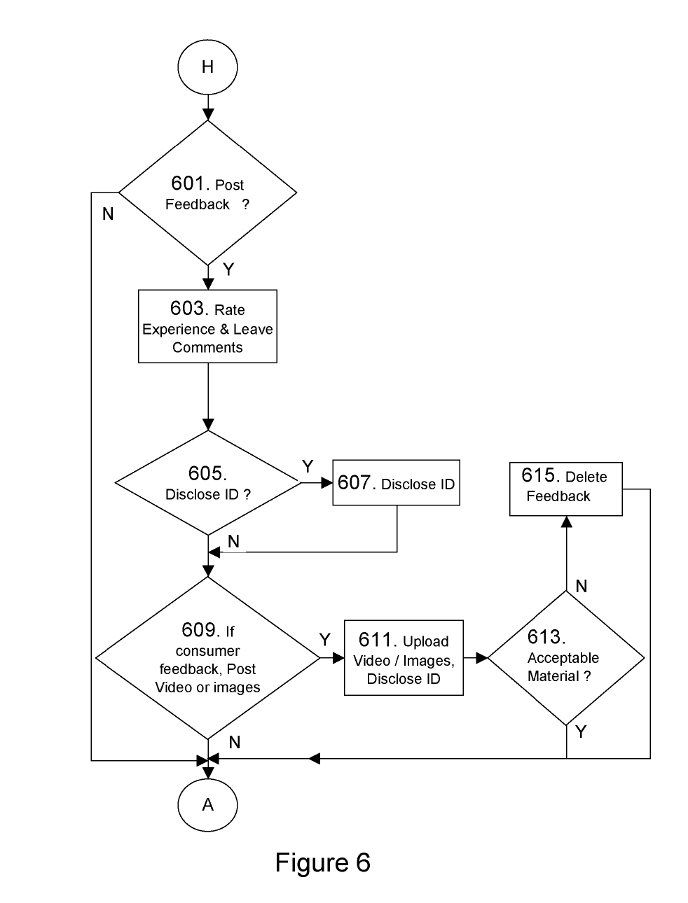

Once the transaction is completed in step 521, both parties have the opportunity to post feedback reflecting their experience with the other party regarding the completed service transaction. The system proceeds to a point H, which is the entry point of an exemplary feedback procedure as shown by way of example in FIG. 6.

FIG. 6 is a flow chart illustrating an exemplary feedback system for a buyer driven bidding system, in accordance with an embodiment of the present invention. In the present embodiment, the feedback system begins at point H. Feedback is divided into two areas for each member, in order to accommodate experiences as both a consumer and service provider, with the process of reporting feedback being the same for both. Feedback is not mandatory and can be left once only per transaction by each party, the decision to leave feedback is made at step 601. If the party does not wish to leave feedback, the system proceeds to point A, shown by way of example in FIG. 1. If the party does wish to leave feedback and is a consumer, feedback may comprise of, but not limited to, ratings in key attributes of service, dependant on category and, or type of service provided, and the posting of a short comment. Alternatively, if the party leaving feedback is a service provider, qualities for consumer are rated accordingly. These ratings and comments are posted on the system in step 603. All members are awarded specific totals per feedback received, based on ratings of attributes relevant to being a consumer or service provider. Further, each member maintains a total rating, as displayed with their ID, which is calculated from an accumulation of historic ratings, as is standard in prior art. The method of rating service providers based on attributes directly related to category and, or service type, as opposed to generic traits as practiced in prior art, is unique to this system. Ratings relevant to service and or category type are essential to the preferred embodiment, due to the vast expanse and depth of services being catered for, thus ensuring detail in service qualities is recognized and projected adequately. To illustrate at a basic level, without limitation, a hairdresser could be rated on different types of haircut or styles, a beautician may rank well in a particular skin treatment or carpenter for working with certain grades of wood.

The need for detail and precise information in feedback is required to generally, promote opportunity through recognition of qualities, enhanced choice, confidence and protection for the consumer. A consumer could also use information to customize and refine contracts, or negotiate to gain favorable terms and pricing, etc, to fit individual transactions, based on a service provider's prior history or limitations. Such detail would allow a consumer to prepare for, and accommodate potential issues, for example, without limitation, if a skilled service provider is known to use cheaper material from past ratings, a consumer may suggest providing their own material for the job, or in another instance a consumer may include a penalty in a contract for a service provider that is historically known for untimely completion of service.

Similarly, service providers can benefit from consumer ratings, as one could without limitation tailor the bid, contract or service to protect from, or accommodate any strength's, problems or weaknesses associated with a particular consumer. For example, but not limited to, a service provider may include special payment terms or payment flexibility for particular consumers depending on their credibility rating.

Some embodiments may comprise a feedback questionnaire that can be answered by various means such as, but not limited to, text blanks or point and click radio buttons. After filling out the questionnaire, the rating of the party for which the feedback pertains is calculated and posted. Then, members can view these questionnaires along with ratings, for other members.

The present embodiment defaults to anonymous feedback for any party leaving feedback, unless the party wishes to disclose their ID. The option to disclose ID is made available at step 605, if opted, ID is disclosed in step 607. Leaving anonymous feedback allows both parties to comfortably communicate thoughts about the transaction and avoid retaliatory feedback or backlash. Feedback left, as comments and, or ratings does not directly reference any particular service ad, contract or job, but is more over a general indicator, in order to maintain anonymity and respect the privacy of each member leaving feedback. This promotes ethical business practice and honesty in both parties. Prior art displays the ID for anyone leaving feedback with comments and ratings referencing particular ads. Honest feedback, or any feedback at all maybe compromised in these systems, in order not to offend the other party or avoid threat of retaliation.

A party may wish to reveal their ID with feedback in step 605, as a reference for contact, to allow others to discuss and question experiences regarding the prospective consumer or service provider. Means of communication include, but not limited to, VoIP, email or messaging, vouching by a third party enhances trust and confidence, for the party making the decision. If the party is a consumer and ratings awarded are positive, he may also opt to, but not limited to, post audio, video or images relative to service received in step 609, as illustration and, or evidence of the quality of service one can expect from a particular service provider. The preferred embodiment restricts inclusion of, but not limited to, visual or audio material in feedback, to positive ratings only. Posting of any visual aid or material as aforementioned, is required to promote and depict positive traits in service received. If the consumer decides to post visual material, anonymity becomes inactive and the true ID of the consumer is displayed by default, in order to maintain integrity within the system and protect service providers from unjust feedback. These videos and, or images are uploaded to the system in step 611. Once videos and, or images are uploaded a service provider has a time restricted opportunity to object to any material posted, at step 613, and have the feedback removed from display, in step 615. Objection and deletion of feedback, etc may arise if the service provider disagrees with what is being portrayed, as some may attempt to unethically exploit the system. For example, without limitation, a consumer could potentially post positive ratings to gain an opportunity to post material, which maybe irrelevant, portraying negative qualities of a service provider, as opposed to the actual service received, in order to tarnish the image of the service provider. Deletion methods of the present embodiment serve as a protective measure in order to ensure, a consumer follows the rules and posts only positive material relevant to service provided, when video, audio or images are part of the feedback. If a service provider opts to have feedback removed, all feedback postings will be deleted for that particular transaction for both parties, with no other opportunity to leave feedback for either party. The system then returns to point A, shown by way of example in FIG. 1. In an alternative embodiment, feedback may be restricted to one party only, or in another embodiment either party may post video or images, to aid feedback, yet in another embodiment, video, audio and images maybe posted, unrestrictive of feedback. Further, in another embodiment, opportunity to leave feedback is time restricted, with activation being from the point of first feedback left by either party or agreement between customer and, but not limited to, service provider of service or transaction being complete. In either case feedback will not be displayed, until both parties leave feedback or time limit has expired, this enhances integrity and eliminates retaliation in the feedback system.

Feedback with evidence enhances the consumer's experience and trust. Furthermore, the ability to watch video or view images of service completed, justifies feedback left as opposed to feedback systems adopted in prior art, that consist of ratings and comments only, with no evidence. Time is also saved in the present embodiment, as a consumer can now view prior work online, without the need to physically visit, in some instances.

Considering the above remedy of restricting the posting of video and images to positive feedback only, with objection and removal being activated by service provider. In another embodiment, it is possible that a consumer may post positive ratings to gain an opportunity to upload video or images and in turn post negative comments with a negative video. In order to avoid this, the system may restrict comments to positive only, through a limited selection of predefined comments in a drop down box, thus denying and restricting an opportunity to manipulate through commentary. In this case, if a consumer attempts to manipulate policies by posting positive comments and ratings, with negative video or images, the system alerts other members of suspicious activity and exposes this type of feedback as a hoax not to be taken seriously. This serves as a protective measure for service provider, in case he is unaware of feedback posted and, or misses the opportunity to intervene and remove feedback in accordance with system policies.

In another embodiment, removal of dishonest feedback is governed by the system administrator, thus reliving the consumer of time restrictions and, or responsibility to intervene. Any reports or complaints of feedback inconsistent with policies, at any time will result in removal of feedback of this type, by system administrator. Even if a dispute arises to validate feedback, such material can justifiably be removed, as it would be in violation of site policies.

Service providers that receive constructive negative feedback and, or low ratings can use the rating system to help them genuinely address weaknesses and improve in lagging areas of service, that might not be apparent otherwise, such as, but not limited to, quality of materials, payment terms, skill, guidance, etc.

In another embodiment, a service provider that receives negative anonymous feedback has an opportunity to respond to the feedback, in order to resolve any issues and maintain ratings. In this embodiment, once the consumer posts feedback, the service provider is given the choice to ‘resolve’, or ‘ignore’ the negative feedback, each response resulting in an update of status, as indicated and displayed next to the feedback, to reflect response given. A response is mandatory from the service provider, otherwise he will be blocked from sending or receiving feedback, until he chooses from an option to ‘attempt to resolve’ or ‘ignore feedback’. If feedback is blocked, it alerts potential customers of a service provider that has not responded to negative anonymous feedback previously received, and may reflect as being uncaring. Blocking of feedback acts to encourage a quick response from the service provider, as he can no longer increase feedback ratings due to inactive feedback. If the service provider chooses to ignore feedback, the status of feedback is changed to “ignored”, with ratings accumulated accordingly and potentially reducing average totals. This may be damaging to the service provider, as it may appear to be an admission of poor work or indifference to the consumer, without concern. If the service provider chooses to resolve the feedback, the status is updated to ‘attempt to resolve’ and ratings received for particular feedback become inactive. An email, internal message or update in status is communicated to the consumer, and it is now up to the consumer to contact the service provider to resolve the issue. If the consumer does not respond, the feedback status remains as “attempt to resolve”, this is an indication of good, or willing gesture on the part of the service provider as he is willing to resolve matters. In this case any negative ratings accumulated through the consumer in question, remain inactive and are not used in the calculation of the service provider's overall accumulated ratings. Inactivity of ratings serves as a means of encouraging a response from the consumer, to resolve the issue or ensure ratings remain active if they feel strongly enough. If the consumer responds and issue is resolved, the consumer changes the status of the feedback to “resolved”, as before any ratings accumulated in the negative feedback become inactive and are ignored in accumulations. This ensures a service provider's average rating accumulated through past service, is not affected and promotes one as an ethical service provider, evidenced by ‘resolved’ status of feedback. If issues remain unresolved after contact, the status remains unchanged as ‘attempt to resolve’, with feedback and ratings active, carrying full weight in rating calculations, as the consumer has responded but still feels feedback ratings awarded are justified. This still leaves the service provider in a creditable position, as status indicates an, ‘attempt to resolve’ was made. In yet another embodiment, negative ratings for an issue that has been ‘resolved’, as indicated through update of status by consumer are deleted completely from display.

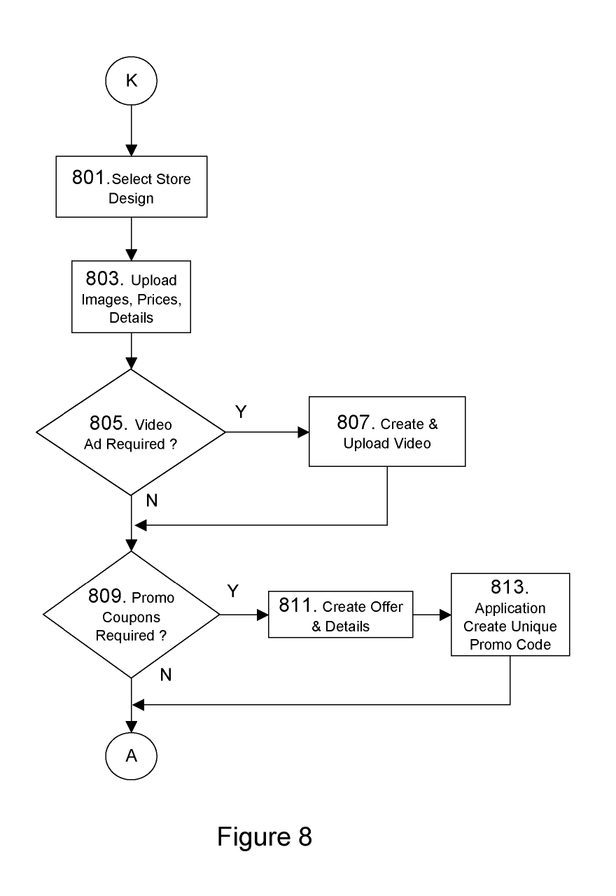

In the present embodiment, members may also set up service stores within the system, incorporating a shopping cart with payment functionality, as currently known to those skilled in the art. FIGS. 7 and 8 are flow charts illustrating an exemplary method for setting up an online store in a buyer driven bidding system, according to an embodiment of the present invention. FIG. 7 illustrates the method from entry point S to a point K, and FIG. 8 illustrates the method from point K to the end of the process. First, a user is asked if he wishes to set up a store in step 701, if not, the system returns to point A, shown by way of example in FIG. 1, otherwise, the user registers or logs in as a member in step 703. Being a service-oriented system, descriptions and examples illustrated in the preferred embodiment preferably provide greater emphasis to services as opposed to products. It should be noted this is by no means a limitation or restriction, in another embodiment, techniques described herein, maybe adopted and applied to, but not limited to, product sales. Each store is created, sorted and ordered by way of chosen categories, subcategories and services offered within. Store operators have options to choose from top-level categories, down to service options within subcategories, allowing merchants to specify in depth, the services in which they specialize or the various categories to which they cater. Store categories, subcategories and service options are based on, but not limited to, the structure of the database as used for creating service ads, in the buyer driven bidding portion of the application. The depth of clarification and detail in services offered, achieved through category hierarchy, ensures the widest array of services are catered for and search results accurately reflect specific demands.

During store set up, a store operator decides what level, or depth of category justifies services offered. A store operator may choose a top-level category, in step 705, for broad coverage, as he may not specialize in one particular area. In which case the store appears in all listings for subcategories and, or services searched, relative to the top level of category selected. Rank of store in search results, is dependant on depth of category, subcategory or service being searched, by consumer.

If a subcategory is required to justify the type of service offered, the store operator chooses this, in step 707, otherwise the store operator proceeds to step 711, to choose services being catered for relevant to the chosen category. If there is a need to go deeper and choose a subcategory within the previously selected subcategory to emphasize expertise in a particular service area, the store operator may do so in step 709. Choosing of sub categories within subcategories continues between step 709 and 707, until the store operator is satisfied with the level of depth being adequate, in accurately representing services offered. Once the store operator has selected the last subcategory, he selects relevant services provided, within that subcategory, in step 711. Selection of individual services is not mandatory a store operator may opt for broad coverage through selection of category or subcategory only, at any level. The process then continues to step 713, where the store operator has the option to return to step 707, to select additional subcategories and services within the pre selected top-level category. Once the store operator is finished selecting subcategories in the top-level category, the system calculates the ‘strength of relevance’ for each category, subcategory and, or service selected, at step 715. An online store may cater to multiple categories, in which case the store operator can opt to select additional top-level categories, in step 717. The process of category and service selection continues in a loop between step 705 and 717, allowing the store operator to increase range and diversity of services offered, upon completion of selection the system proceeds to point K. In another embodiment, the calculation for strength of relevance could be executed at the end, after final selection of categories, subcategories and services.

Strength of relevance is a calculation performed to, but not limited to, determine rank of store in search results. A percentage is allocated to, but not limited to, each selection of category, subcategory and, or service at each level, determined by, but not limited to, the total number of categories, subcategories or services selected by store operator, at each corresponding level, for a particular store. The system divides, without limitation, each chosen selection with the total generic selection at the same generic level. The percentage output for each selection (category, subcategory or service) represents concentration of each selection, within its, but not limited to, generic category, subcategory, service and level, in the same store. Other factors determining rank in search results include, but not limited to, locality and feedback rating.

For example, without limitation, if the operator of store A chooses the top-level Automotive category and also the top-level Animal/Pets category as two categories catered for by the store, the system will display store A in results, for a consumer searching for automotive or animal/pet services in the same locality. In this case, store A is listed amongst other stores, with rank dependant on, but not limited to, depth of consumer search combining proximity and, or feedback rating. Strength in relevance indicates store A has 50% relevance to the search criteria, as store A is serving two categories at the same level, and thus has 50% relevance in each category. Stores with a greater percentage of relevance, through fewer categories or services offered at the same level, result in higher ranking, for example, without limitation, if Store B serves Automotive only equating to 100% relevance it would take precedence over store A in rank, if search parameters remained the same. Stores offering greater coverage of categories and, or services, at the same level, result in a decrease of relevance, concentration and specialization in one particular area, thus resulting in lower rank. For example without limitation, if store B catered to Automotive, Animal & Pets and Entertainment, it would now rank lower than store A if a search was performed for Animal & Pets, as each top-level category served represents 33.33 . . . % each, of the total store, at the same level. A store serving fewer categories and, or services at the same level will likely have greater concentration of resources and, or attention devoted to the limited offerings, as opposed to a store serving many categories at the same level. This enables a consumer to pick and choose in accordance to a hierarchy of displayed results, sorted by strength in relevance and concentration, to the search parameters. In the present embodiment, all results are relevant to location and radius as per consumer search, for practicality and ensure convenience. A consumer may search at any level of depth and be as specific as need be, within the bounds of the system, as results in rank ensure all stores are listed in order of concentration. Any store specifically set up to cater to a particular service within a subcategory regardless of depth, being searched, takes precedence in rank over any other store serving at a higher level within the same generic category, as each parent level reflects a reduction in relativity to search.

Stores designated in higher level parent categories opt to serve in those categories due to their broader coverage of services and do not consider them-selves to be specialists in options available.

In some embodiments, the store operator may have the option to indicate a percentage or rating for the categories or services chosen. For example a bakery that custom designs pet treats and cakes may be listed under a baked goods category. However, in the present example the pet treats are a minor part of the business. Therefore the store operator may not want the store to be rated as 50% relevant in each selection. Instead, the store operator may want the store to be rated as 80% relevant to cakes and 20% relevant to pet treats. Using this method a store operator may allocate a percentage manually based on specialization in different services, at each level. This method is unlike a search engine that uses keywords, link popularity, algorithms and various other methods to calculate and display results, without relevance to, how concentrated or specialized one store maybe over another. In the present embodiment, a consumer also has the option to display results combining and, or prioritizing parameters such as, but not limited to, feedback rating, proximity and or relevance. This enables a consumer to view results in an order of preferred importance, as opposed to default. For example, a consumer may prefer order of results to be prioritized by relevance first, then feedback rating as a secondary measure as opposed to proximity, or another combination. A consumer may also combine store details dependant on industry and or service type as parameters in search, these include but not limited to fees, hourly rates, resources, equipment, technology, academics, experience, structure, sales, size, etc., thus allowing search and rank based on preferred merits. This promotes flexibility in search, ensures fairness in ranking and discourages manipulation to enhance rank by store operators, as it is the consumer that decides which parameters are of more importance to them, in determining hierarchy of results displayed, not convention.

The following is another illustration of rank in search at subcategory level. For example, without limitation, if service store B indicates within the top-level automotive category, that it specializes in the subcategory of tires only, the system lists store B with 100% relevance for a consumer searching for tires, assuming the locality is the same for store B and the consumer. If there is another store specializing in the subcategory tires, that is located closer to the consumer, store B is displayed as possibly the next best option. Further if store B offers a fitting service only, within the subcategory of tires, and a consumer is searching for a fitting service in the same locality, store B is listed above other stores, even though there may be other stores identical in everything offered including fitting service, and more services relative to tires. Store B is ranked higher in this case as it has a higher % of concentration of service in fitting as opposed to some of the other stores offering numerous tire services. For the consumer, the search locates exactly what is required in the most concentrated form and closest in proximity, and from here it is up to the consumer to decide which store is most suitable from the listed results. Beyond this the system will then list others determined by concentration of service and then stores serving the subcategory, at the same level. Each generic parent level will then follow suit, listed lower down accordingly, with proximity as a secondary measure.

One could argue the more service options being offered by a store, the more specialized the store must be. However, if the system operates with emphasis on the number of services offered, store operators may attempt to maximize the number of services being offered by their store in the hope of obtaining a higher ranking in listed results. Many stores could falsely claim services being offered that they may not necessarily specialize in, defeating the object of the system. The methodology of limiting categories and services offered by store operators for better ranking in listed results generally ensures and encourages a store operator, only opts for categories and services that they truly specialize in, even though they may cater for others. By opting for excessive categories, subcategories and or services, the store reduces the strength of concentration in what it really specializes in, thus resulting in a lower ranking in listed results during a search. In this case it is better for a store operator to choose a higher-level parent category or categories and qualify for broader coverage in their area of trade or service, to ensure their store is listed in all relevant searches. Store operators that might try to falsify or manipulate the system in terms of their expertise, will most likely be exposed through any feedback received from consumers. It is in the best interest of any store operator to maintain a top rating in feedback, as feedback is displayed and used as part of the calculation for stores that might tie in search ranking and proximity, or preferred rank order. This method acts as a deterrent to store operators and a tool to maintain integrity in the system.

Store operators can confidently mix the level, depth, and diversity of categories and services for which they cater, as the search options offered to the consumer are a reflection of the same hierarchical depth of categories and service set up options, offered to store operators. This generally ensures that all results are relevant and precise to information on the database in real time.

The present embodiment assists all at a local, national or international level and could be considered especially useful to those consumers that require an instant search of only those stores serving their specific discerning needs. The system enables location of niche service providers efficiently and effectively, with minimal effort.

Means to locate service with precision to requirement, according to the present embodiment, results in time saved experimenting with service providers, reduction in mismatched service and reduced expense as a result of error, or use of service providers lacking proficiency in the field.

Referring to FIG. 8, beginning at point K, a store operator may select from varying store designs, in listing and, or displaying goods and services in step 801. Images are then uploaded and prices input, in step 803, as is standard in prior art techniques. Furthermore, in some embodiments a store operator may additionally without limitation, input a store profile describing services, establishment, experience, etc, as an introduction to potential consumers. In the present embodiment, store operators setting up service stores have the option to produce commercials using video in step 805, in order to perform functions such as, but not limited to, introducing themselves, touring and promoting their physical location, testimonials, display and, or promotion of products, services, skills and performance in “on demand advertising”. These video ads are uploaded in step 807.

Video enables consumers to familiarize themselves with an online store, service provider and, or physical premises of offline store prior to visiting and, or transacting, thus providing an added degree of comfort, trust and knowledge regarding the store and, or management, as opposed to just images and descriptions. This is especially useful for service providers wanting to enhance business through presentation. Prior art approaches have not incorporated video advertising for, by way of example and not limitation, companies, established merchants, new service providers, online/offline providers, together or individually in one system, in this type of buyer driven, service oriented environment, or any other system, environment or application. It is contemplated that embodiments of the present invention based on this approach are a relatively cost and market effective approach to advertising and broadcasting; that is, through integration of video backed by consumer rating of service, all without the exuberant cost of traditional advertising and, or wide exposure.

Other systems incorporating means of advertising, deliver pop-up ads and, or streaming of ads, on a designated area of a web page, resulting in ineffective and often ignored advertising. Static images may work well for product oriented systems, but inept in display of services. Further, certain websites streaming video of, but not limited to, news and, or entertainment articles, subject an individual to preview an ad commercial, prior to viewing the selected content of interest. This can also result in a time consuming, ineffective and irritating experience. The present embodiment promotes “on demand advertising”, whereby a consumer visiting a service store or viewing an ad request can choose to play the video of interest, without imposition of third party ads. Advertising to a captive audience, promoting user control proves a much more powerful tool than prior systems.

Other methods of advertising, without limitation, services or businesses, onscreen or otherwise can be misleading in terms of experience, quality and skill without real time evidence or rating of public opinion. Glossy customer testimonials or other luring techniques, vouching prior interaction with service provider can be unconvincing and ineffective in serving the purpose intended. For this reason and or, but not limited to, promotion of services/business, etc, a coupon advertising and redemption program has been formulated for the present embodiment, to enable retrieval, tracking and posting of feedback and, or ratings in real time, for products and services provided by all. This enables all service providers to promote business and simultaneously build honest factual recognition in the community and, or universally.

The option of participating in a promotional coupons program is available to the store operator at step 809. If the store operator wishes to offer coupons, they are created using a design tool, and or, but not limited to, blank customizable or predefined templates, containing offers, discounts, etc, available within the application, at step 811. The present embodiment incorporates standard font and image tools, enabling a store operator to customize the style of coupon including, without limitation, fonts, colors, uploading or resizing images, dragging and dropping, etc. Ad information such as, but not limited to, promotion details, expiry date, address, etc, relevant to the offer is input accordingly in predefined, or selected areas of the coupon.

Unique promotional codes are generated by the system for all coupons, whether for online or offline redemption, in step 813. The code generated is specific to the coupon and contains details regarding, but not limited to, the discount or promotion and service provider, for tracking and marketing purposes. Coupons enable service providers to target market consumers that are already visiting the store and interested in something the store has to offer, which can be much more effective than chance marketing. Promotional codes enable evidence of transactions through redemption, without this it would be difficult to operate a credible feedback system. These coupons are then made available in service stores registered in the system, for consumers to, but not limited to, download and print for redemption at physical locations, or apply in online or phone based transactions. After the coupon is created or if the store operator does not wish to create a coupon, the system returns to point A, shown by way of example in FIG. 1.

In another embodiment, upon design and creation of coupon and, or promotional code, as previously described, without limitation, to size, material, etc. Coupons are ordered to and distributed from, but not limited to, service/store premises, as opposed to online redemption or consumer downloads. Service providers then, without limitation attach or apply the coupons to products and, or services during transaction, as a means of, but not limited to, enabling and tracking feedback, promoting a deal, event or communicating a message, directly to, but not limited to, consumers. For example, without limitation, a service provider selling sandwiches or pizzas, could promote, an evening special, new product, or new location, to customers by attaching the aforementioned coupon to the opening wrapper or box of product, thus ensuring coupon must be detached prior to opening product, thus ensuring message is communicated effectively. A customer could then redeem the coupon at another time and, or enter the promotional code online and leave feedback in the system regarding their experience. Feedback entered would consist of, but not limited to, comments and ratings as described in the preferred embodiment. The service provider could then login to the system and monitor feedback for products, services, and success of promotion, consisting of, but not limited to, comments, ratings, percentages, graphs, etc, as calculated by the system, depicting incline/decline in service ratings and, or success of promotion on a weekly, monthly, quarterly and, or yearly basis, thus enabling comparative analysis in customer service and exposure to improvement. Further, entry of consumer feedback online results in honesty, through privacy and comfort associated, as opposed to customer comment boxes on service premises. It is understood the aforementioned may be incorporated in the preferred embodiment or operated as a separate system.

FIG. 9 is a flow chart illustrating an exemplary process for a consumer to search for a store in a buyer driven bidding system, in accordance with an embodiment of the present invention. Consumers may locate service stores through, without limitation, keyword search, general browsing or specified search as described, herein. In the present embodiment, the entry point of the store search process is point C, also shown by way of example in FIG. 1. The normal course of action for a consumer to find a store begins with searching categories in step 901 and selecting the category, subcategory and, or service required, at step 903. Other options available in narrowing search include, but not limited to, location, radius, and feedback rating. The system then performs the aforementioned calculation to determine strength of relevance and concentration to search criteria in step 905, and generates a listing of service stores in order of distance and significance to search parameters. Proximity of results default to registered location of user, unless otherwise specified. A consumer may opt to have results ordered by preferred parameters or combination thereof, at this point.

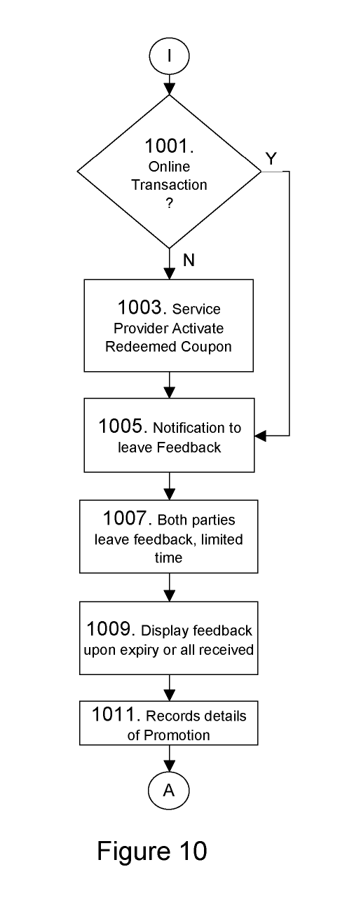

Next the consumer views the generated listing of stores and determines if interested, in step 907. If the consumer is not interested in any of the stores listed, he may choose to search for more stores in step 909, in which case the system returns to step 901, enabling further search of categories. If the consumer does not wish to search for more stores, the system returns to point A, shown by way of example in FIG. 1. If at step 907, the consumer is interested in a store, the consumer can view store information, which may include, but not limited to, video and, or audio presentations, images, information and prices for products and services, and, or any other input during set up, in step 911. A consumer then determines if there are coupons advertised relative to a product or service of interest, at step 913, if not the system proceeds directly to step 919. If there is a coupon of interest, it is activated in step 915, whereby the system generates an individual promo code that serves to track and identify the consumer using the coupon, the promo code is then integrated with any previously generated code, for the discount or promotion. In another embodiment, coupon codes may be fully generated during selection or purchase of products and, or services, as opposed to separate formation and integration. Then at step 917, depending on the application of the discount, the promo code is then printed on the coupon designed by the store operator, for use in an offline transaction, or displayed and, or saved for an online transaction. It is assumed a consumer may select multiple products and, or services, in which case numerous coupons and, or promo codes will be generated, where applicable. The system then proceeds with application of promo code and or redemption of coupon in, but not limited to consumer purchase of product and, or service online, or at the designated offline location, in step 919. Upon purchase, the system advances to a point I, which is the entry point of an exemplary process for recording redemption of coupon and submitting feedback, as shown by way of example in FIG. 10. Otherwise, if consumer is uninterested in purchase, the system returns to point A, shown by way of example in FIG. 1.

FIG. 10 is a flow chart illustrating an exemplary process for recording redemption of coupon and submitting feedback in a buyer driven system, in accordance with an embodiment of the present invention. In the present embodiment, the process of recording redemption and submitting feedback begins at point I. At step 1001, the system determines whether the promo code applied was for an online transaction, if so redemption is recorded and feedback enabled for both parties, by default, control then passes to step 1005. Otherwise, upon redemption and physical receipt of coupon at premises, a store operator logs into his account, to register receipt of coupon, in step 1003, in order to enable feedback for marketing purposes. Both parties are then sent confirmation of the activated coupon through means such as, but not limited to, internal messaging or email in step 1005 and given a, but not limited to, time-restricted opportunity to leave feedback regarding transaction in step 1007.

In the present embodiment, the system generally ensures, a store operator registering activation of a coupon in an offline transaction, receives a fair objective opinion and or feedback rating, from the consumer, for, but not limited to, services provided. As control of coupon registration and feedback activation is discretionary to store operator, thus ensuring a consumer would typically not push a service provider and test limits purposefully, as the consumer knows that the service provider can potentially protect himself by not activating the coupon on the system, in which case feedback cannot be left by either party. Leaving no feedback is in neither party's interest; however, this option provides a degree of protection from those that might try to leave unjust feedback, manipulate ratings and, or take advantage of the system.

Once feedback from both parties is received, or time expires to leave feedback, feedback left by either party is displayed in step 1009. Neither party can view the other party's feedback prior to leaving their own feedback within the time allocated, as a protective measure from retaliatory feedback and to maintain honesty and fairness to all. Feedback posted by a service provider is automatically posted in the profile of the consumer that originally redeemed the coupon and vice versa, hence the promo code, which is used to track and ensure feedback, is posted to the relevant party only. The present embodiment uses the promo code to record statistics and information such as, but not limited to, the type of offer, expiry date, number of coupons redeemed, consumer ID, ratios, percentages, graphs, charts, weekly, monthly, yearly comparisons and demographics of redemption, for future marketing data, accessible to the store operator, in step 1011. The system then returns to point A, shown by way of example in FIG. 1.

The recording and tracking of coupon information is another means of targeted advertising and promotion of integrity in feedback system. Time limitations in posting feedback generally ensure feedback relative to a particular promotion is received within an adequate time frame, in order to accurately assess the success of a promotion. The feedback system provides opportunity in obtaining an opinion and, or rating in service, for all service providers, stores and businesses that have restricted means of obtaining recognition of service, in the community or otherwise. Coupons advertised in service stores provide a traceable connection between the consumer and all service providers and businesses, with a means to leave and receive genuine feedback for all, regardless of if they participate in the buyer driven environment within the system. In another embodiment, feedback could be one-way and restricted to one party only and, or implemented in a separate system.

The preferred embodiment of the present invention incorporates all of the features previously described; however, alternate embodiments may incorporate various combinations of the features described above. For example without limitation, one embodiment may incorporate competitive bidding and feedback features and no appointment system or in another embodiment, the option to create an online store may be eliminated. Yet another alternate embodiment may exclude coupons and, or limit communication features.

In an alternate embodiment, a classified service ad application comprises consumer requests for service, that are uploaded as, but not limited to, images, text and, or videos played to potential service providers on a website, as an illustration or description of service requirements. In this particular system, quotes are forwarded or emailed directly, the consumer then communicates using means such as, but not limited to, internal messaging, email and or chat rooms with interested service providers and negotiates a suitable price accordingly. This embodiment is not an auction or competitive bid system; it is a more basic embodiment of a system for matching consumers and service providers in an online buyer driven environment.

In another alternate embodiment, it is possible to distribute video and communicate through VoIP to interested parties using a peer-to-peer network. Organization, file sharing, view and access of files, is well known in prior art, peer-to-peer file sharing networks. In this embodiment, members choose the relevant category of service to advertise in on the system and save files describing service needs in a shared network folder(s) on their own system. The category structure accommodating search and organization of files on the primary system, serves as a link to shared folders on the network, that are accessible to all members in the network. Service providers log in, opt a category and input a title referencing the type of service and locality being searched. The title description used by members in saving files follows a standard specific to the system in describing the service required and locality of request. Organization and names of folders follow a similar standard, in order to avoid discrepancies in search and maintain integrity in organization. The system then performs a search on the network and displays a listing of files found, relevant to the search parameters. Each title found in the listing serves as a reference and location to, without limitation, a video file accessible in shared network folder(s) saved on the consumer's computer or other networked device. This embodiment is organized as stated by dividing categories of service referencing shared folders to include, but not limited to, video files referencing titles to service ads. A service provider may click the title of a video file of interest, which in turn downloads the file from sources (other users) available on the network. Consumers and service providers may then discuss the service request using means such as, but not limited to, VoIP, email and message boards and post bids to the site in an auction environment, with bids organized to reference the title of the service ad. This embodiment is available only to members of the peer-to-peer network, where each member is required to download software to enabling accessibility to the system. The system also caters to feedback for all parties Involved. This particular type of application reduces costs associated with storing content and distributing or streaming files from a separate server. In an alternative embodiment it is possible for the system as described, to operate serving classified ads with no bidding. In another embodiment it is also possible the application could cater to products, in an auction or classified environment.

In yet another embodiment, sealed bids may be received over a network after a registered service provider views the video or other information associated with the service request. In a variation it is also possible the service provider may discuss the service requirements directly with the consumer after viewing video, using means such as, but not limited to, messaging or email, communicating to an anonymous consumer ID or email address, in order for the consumer to maintain privacy. Upon receiving all bids, the bids are opened simultaneously at a specific time within the system, to determine the winner. In another embodiment the consumer could preset winning conditions within the system to automatically select a winner; conditions could be, but not limited to, feedback, distance, experience and, or warranty. In yet another embodiment, a consumer may disclose identity to further discuss details as necessary, before choosing a winning bidder. Sealed bids provide a consumer with true insight to market rates in a non-competitive, private environment, for the service requested.

In yet another alternate embodiment, businesses and service providers may register themselves in the system to receive notification of service requests in, without limitation, categories, dates and, or localities of choice. Consumers then upload, without limitation, videos and/or other criteria regarding the service request in their perspective, but not limited to, categories, specifying dates, localities, etc. The system then compares requests with service provider input and notifies qualified service providers matching ad criteria, via, but not limited to, email containing a link to Ad. The system allows for both parties to be as specific as needed, without limitation, in order to ensure all detailed requests may be catered for. Ads may also be searched for directly by registered businesses or service providers through, but not limited to category, date and, or locality, etc. Registered service providers then review theses requests and pursue further information via, but not limited to, email, VoIP, etc, or forward pricing directly to the consumer, maintaining privacy for all parties involved, if desired. Depending on quotes received and prior feedback, a consumer may then choose which service provider to use or discuss service with.

A further variation of the aforementioned embodiment comprises a, but not limited to, predefined price, condition or constraint as specified by the consumer, for service providers to take into account when bidding. Possibly setting limits of, for example, the highest price the consumer is willing to pay and, or particular quality required and, or special material required. A service provider could then perform a search combining different variables for specific searches.

Yet a further variation of the previous embodiment may direct all service provider responses back to a secure server, after viewing of service video or other types of ads. A consumer interested in bids received may then retrieve the bids by paying a small fee for each bid of interest or a preset fee allowing unlimited retrievals.

In another variation of the above embodiment a consumer may specify a minimum feedback rating of those service providers to which videos or other types of ads may be forwarded and, or accessible to.

In yet another embodiment, a consumer may upload information such as video, images and, or description of services required, with a price he is willing to pay. Interested service providers may then view ads and forward questions and, or bids to the consumer using means such as, but not limited to, email, VoIP, or a message board. The consumer may then check historic feedback and other details, if the consumer is satisfied that the service provider is qualified, he then answers questions accordingly and, or accepts bid. At this point, an automated message is sent to those service providers the consumer determines unqualified. At intervals the system or the consumer (manually) may decrease the price of acceptance for the service request, in order to create competition until a satisfactory service provider is found, willing to provide service at the desired price. If no bids are satisfactory, the consumer has the option to re-advertise the service request. Upon completion of service, a consumer can leave feedback accordingly.

In a further embodiment, or as integration with prior embodiments, both parties could use video as a platform to address on going progress and refinement of a service request, promoting flexibility for time restricted users. In this particular situation video could be used to record aspects of work being performed, then used in discussing restrictions, choices, preferences, etc, without the need for both parties to be physically present at the service location, at the same time.

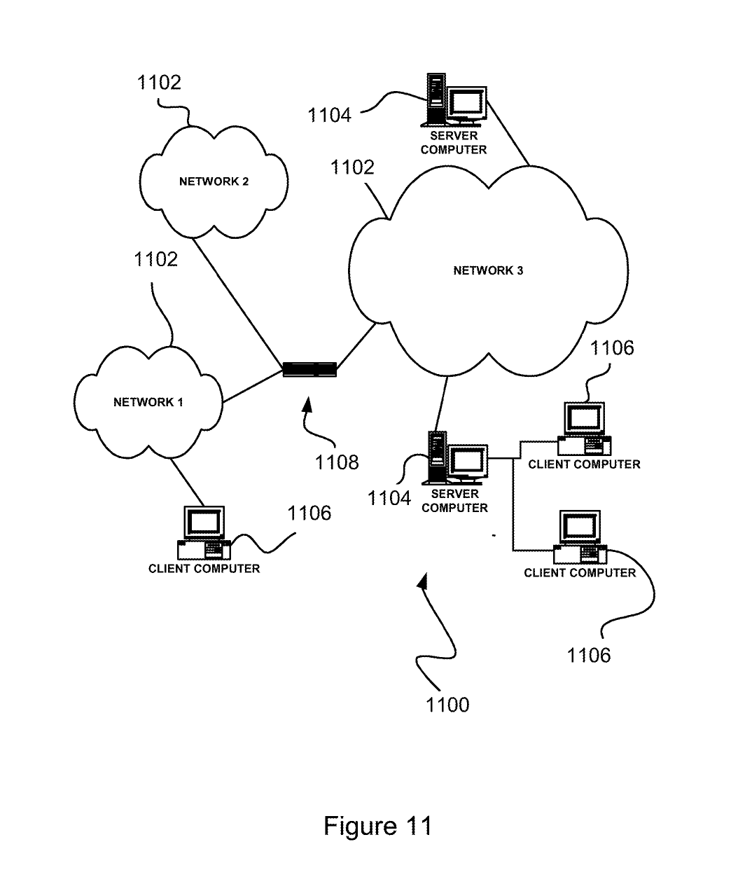

FIG. 11 illustrates a client-server network architecture 1100 that, when appropriately configured or designed, can serve as a computer network in which the invention may be embodied. As shown, a plurality of networks 1102 is provided. In the context of the present network architecture 1100, the networks 1102 may each take any form including, but not limited to a local area network (LAN), a wireless network, a wide area network (WAN) such as the Internet, etc.

Coupled to the networks 1102 are server computers 1104 which are capable of communicating over the networks 1102. Also coupled to the networks 1102 and the server computers 1104 is a plurality of client computers 1106. Such client computers 1106 may each include a desktop computer, laptop computer, mobile phone, hand-held computer or device, any component of a computer, and/or any other type of logic. In order to facilitate communication among the networks 1102, at least one gateway or router 1108 is optionally coupled there between.

It should be noted that any of the foregoing components in the present network architecture 1100, as well as any other un-illustrated hardware and/or software, may be equipped with various message management features.

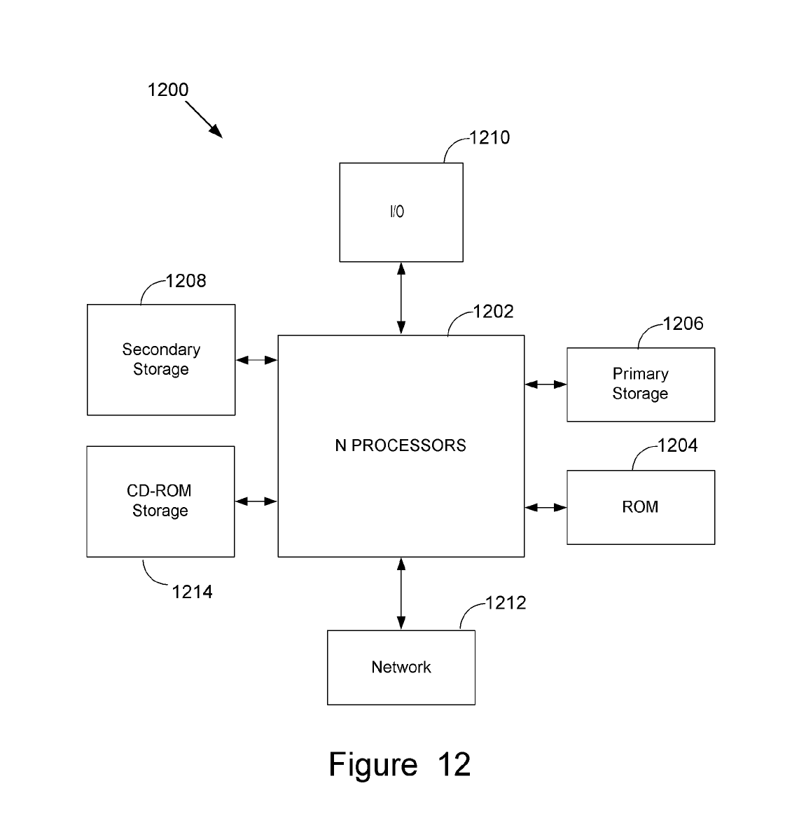

FIG. 12 shows a representative hardware environment 1200 that may be associated with the server computers 1104 and/or client computers 1106 of the previous Figure, in accordance with one embodiment. The computer system 1200 includes any number of processors 1202 (also referred to as central processing units, or CPUs) that are coupled to storage devices including primary storage 1206 (typically a random access memory, or RAM), primary storage 1204 (typically a read only memory, or ROM). CPU 1202 may be of various types including microcontrollers (e.g., with embedded RAM/ROM) and microprocessors such as programmable devices (e.g., RISC or SISC based, or CPLDs and FPGAs) and un-programmable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 may also be coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications or internet network using an external connection as shown generally at 1212, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC § 112 (6) it is intended that the corresponding means for and/or steps for carrying out the claimed function also include those embodiments, and equivalents, as contemplated above that implement at least some novel aspects and objects of the present invention in the jurisdiction of the USA. For example, processing of information input by and output to members and rendering page display accordingly, process page layout depicting service tabs dependant on chosen category, activation of mandatory questions to be answered during creation of service ad and verification of license during registration, media and file content receipt, organization, delivery and distribution of including video, audio, images as requested in ads or feedback, technology and servers enabling video and voice communication, VoIP technology, location of servers, bid processing, generation and issue of anonymous ID in posting ad for consumers and anonymous ID in bidding for service providers as per request, generation of map with service request/bid details as pointers, process disclosure of consumer ID upon request when leaving feedback, appointment processing as per input request and responding accordingly, calculation of store relevance and concentration in products and services as per selected categories and parameters input, generation and processing of coupons and promotional codes for marketing and tracking of feedback for service stores including time restrictions and automated responses, technology in peer to peer network including primary server governing distribution and retrieval of files including video and audio and all server side processing and output dependant upon consumer input may be performed and/or located outside of the jurisdiction of the USA while the remaining method steps and/or system components of the forgoing embodiments are typically required to be located/performed in the US for practical considerations.

Other contemplated embodiments of the present invention include page layout using tabs as options in service, while forms requesting mandatory information regarding Ads are known in prior art, but are not generally used in buyer driven competitive bid environments.

Having fully described at least one embodiment of the present invention, other equivalent or alternative means for implementing a method and system for buyer driven bidding and commerce according to the present invention will be apparent to those skilled in the art. For example, without limitation, the above embodiments describe the system as being used by service providers; however, some embodiments may be implemented for the selling of products, or of product and services simultaneously. The invention has been described above by way of illustration, and the specific embodiments disclosed are not intended to limit the invention to the particular forms disclosed. The invention is thus to cover all modifications, equivalents, and alternatives falling within the spirit and scope of the following claims.

Any claim elements and steps herein that have been numbered and/or lettered are solely done so as an aid in readability and understanding. Hence, any such the numbering and lettering in itself is not intended to and should not be taken to indicate the ordering of elements and/or steps in the claims.

What is claimed is:

1. A method for a buyer driven e-commerce for services in a client/server environment, the client being programmed by an e-commerce provider to effectively act as a proxy of the e-commerce provider to present the buyer with information and appropriately respond to related requests from the buyer that are communicated to the server(s), the method comprising steps of:
the client communicating with said e-commerce provider for the purpose of locating a service provider of a service;
the client, communicating a request to place an advertisement on said web site, and communicating a category of services that corresponds to said service;
the client, communicating a service option related to said category selected;
the client, communicating information related to questions regarding said service option;
the client receiving bid information from said e-commerce provider, the bid information being related to bids for said advertisement, the bids being selected by said e-commerce provider at least based upon said e-commerce provider locating at least one prospective buyer of said provider's services, and said e-commerce provider accessing said advertisement under said service option under said category, and
the client communicating to said provider an acceptable provider bid for said service.

2. The method as recited in claim 1, further comprising the steps of:
said provider connecting to said web site for the purpose of locating buyers of said provider's services;
said e-commerce provider accessing said advertisement under said service option under said category;
said e-commerce provider choosing to bid on said requested service;
the buyer reviewing bid information related to said advertisement; and
after reviewing said bid information, the buyer choosing an acceptable service provider for said service.

3. The method as recited in claim 1, further comprising the step of the client communicating a multimedia file comprising further descriptive information related to said required service; and,
the client, requesting that said information and said multimedia file be posted to said web site as said advertisement under said service option under said category;

4. The method as recited in claim 1, further comprising the step of the buyer providing feedback regarding said acceptable provider to be posted on said web site and used in rating said provider.

5. The method as recited in claim 4, wherein said feedback comprises a video file illustrating service provided by said provider.

6. The method as recited in claim 1, further comprising the step of said provider providing feedback regarding the buyer to be posted on said web site and used in rating said buyer.

7. The method as recited in claim 1, wherein the step of choosing an acceptable provider further comprises the buyer reviewing posted feedback and rating of said provider.

8. The method as recited in claim 1, wherein the step of choosing to bid on said required service further comprises the provider reviewing posted feedback and rating of said buyer.

9. The method as recited in claim 1, further comprising the step of the buyer and said provider communicating through VoIP to facilitate the bidding process.

10. The method as recited in claim 1, further comprising the step of said provider requesting an appointment with the buyer and the buyer responding via an automated appointment system on said web site.

11. The method as recited in claim 1, further comprising the step of said bid being posted on said web site by said provider.

12. The method as recited in claim 1, further comprising the step of said provider setting up a store on said web site.

13. The method as recited in claim 12, wherein said step of setting up a store further comprises providing a video file as a means for introducing said provider and services provided by said provider.

14. The method as recited in claim 1, further comprising the step of the buyer searching stores on said web site using categories and service options.

15. The method as recited in claim 14, further comprising the step of the buyer receiving a map indicating locations of providers resulting from buyer's search.

16. A system for buyer driven e-commerce for services, the system comprising:
a web site accessible to buyers of services and providers of services;
a plurality of categories and related service options on said web site from which the buyer may choose to place an advertisement for required service;
informational questions, presented to the buyer, regarding said service option where the buyer chooses to place said advertisement;
means for the buyer choosing to place said advertisement to include, in said advertisement, a video file to further describe and clarify said required service;
means for posting the buyer's advertisement under said service option under said category;
browsing means for providing said provider access to the buyer's advertisement;
means for allowing said provider to bid on the buyer's advertisement;
means for the buyer to review bids on said advertisement; and
after reviewing said bids, means for the buyer to choose an acceptable provider for said required service.

17. The system as recited in claim 16, further comprising means for the buyer to provide feedback regarding said acceptable provider to be posted on said web site and used in rating said provider.

18. The system as recited in claim 17, further comprising means for said provider to provide feedback regarding the buyer to be posted on said web site and used in rating said buyer.

19. The system as recited in claim 16, further comprising means for the buyer to review posted feedback and rating of said provider.

20. The system as recited in claim 16, further comprising means for said provider to review posted feedback and rating of said user.

21. The system as recited in claim 16, further comprising means for the buyer and said provider to communicate through VoIP to facilitate the bidding process.

22. The system as recited in claim 16, further comprising means for said provider to request an appointment with the buyer and the buyer to respond via an automated appointment system on said web site.

23. The system as recited in claim 16, further comprising means for said provider to post said bid on said web site.

24. The system as recited in claim 16, further comprising means for said provider to set up a store on the web site.

25. The system as recited in claim 24, further comprising means for said provider to provide a video file as means for introducing said provider and services provided by said provider.

26. The system as recited in claim 16, further comprising means for the buyer to search stores on said web site using categories and service options.

27. A method for buyer driven e-commerce for services, the method comprising:
steps for the buyer to connect to a web site for the purpose of locating a provider of a service;
steps for the buyer to choose a category of services that corresponds to a required service;
steps for the buyer to choose a service option related to said category selected;
steps for the buyer to provide information to questions regarding said service option and a video file to further describe and clarify said required service;
steps for the buyer to request said information and said video file to be posted to said web site as an advertisement under said service option under said category;
steps for said provider to connect to said web site for the purpose of locating buyers of said provider's services;
steps for said provider to set up a store on said web site;
steps for said provider to access said advertisement under said service option under said category;
steps for said provider to choose to bid on said required service;
steps for the buyer and said provider to communicate through VoIP to facilitate the bidding process;
steps for the buyer to review bids for said advertisement;
steps for the buyer to choose an acceptable provider for said required service;
steps for allowing the buyer to provide feedback regarding said acceptable provider; and
steps for allowing said provider to provide feedback regarding the buyer.

28. The method as recited in claim 27, further comprising steps for said provider to request an appointment with the buyer and the buyer to respond via an automated appointment system on said web site.

29. The method as recited in claim 27, further comprising steps for the buyer to search stores on said web site using categories and service options.

30. A computer program product for buyer driven e-commerce for services, the computer program product comprising:
computer code for a web site accessible to buyers of services and providers of services;
computer code that provides a plurality of categories and related service options on said web site from which the buyer may choose to place an advertisement for required service;
computer code that provides informational questions, presented to the buyer, regarding said service option where the buyer chooses to place said advertisement;
computer code that provides means for the buyer choosing to place said advertisement to include, in said advertisement, a video file to further describe and clarify said required service;
computer code that provides means for posting the buyer's advertisement under said service option under said category;
computer code that provides browsing means for providing said provider access to the buyer's advertisement;
computer code that provides means for said provider to set up a store on the web site;
computer code that provides means for allowing said provider to bid on the buyer's advertisement;
computer code that provides means for the buyer to review bids on said advertisement;
computer code that provides means for the buyer to review posted feedback and rating of providers;
computer code that provides means for the buyer and said provider to communicate through VoIP to facilitate the bidding process;
computer code that provides means for the buyer to choose an acceptable provider for said required service;
computer code that provides means for the buyer to provide feedback regarding said acceptable provider;
computer code that provides means for said provider to provide feedback regarding the buyer; and
a computer-readable medium that stores the computer code.

31. The computer program product as recited in claim 30, further comprising computer code that provides means for said provider to request an appointment with the buyer and the buyer to respond via an automated appointment system on said web site.

32. The computer program product as recited in claim 30, further comprising computer code that provides means for the buyer to search stores on said web site using categories and service options.
